(19) United States
(12) Patent Application Publication
(10) Pub. No.: US 2008/0319782 A1
(43) Pub. Date: Dec. 25, 2008

(54) METHODS OF COLLECTING AND VISUALIZING GROUP INFORMATION

(75) Inventor: Bradley L. Good, La Canada, CA (US)

Correspondence Address: PERKINS COIE LLP, P.O. BOX 1208, SEATTLE, WA, 98111-1208, US

(73) Assignee: OURGROUP, LLC, La Canada, CA (US)

(21) Appl. No.: 12/144,520

(22) Filed: Jun. 23, 2008

Related U.S. Application Data
(60) Provisional application No. 60/945,908, filed on Jun. 23, 2007.

(51) Int. Cl. G06Q 99/00

(52) U.S. Cl. 705/1

(57) ABSTRACT

A system and methods allow groups to be managed. Various methods of collecting and visualizing group information are described. A group head and various members of organizations can organize fundraising activities. Group performance can be rated and displayed. Various group successes can be reported.

### RELATED APPLICATIONS

This Application claims priority to U.S. Provisional Patent Application No. 60/945,908, filed Jun. 23, 2008, and entitled “METHODS OF COLLECTING AND VISUALIZING GROUP INFORMATION” by Bradley Good, which is incorporated herein by reference.

### BACKGROUND

Often groups engage themselves in fundraising to provide capital necessary for furthering the group interest. Individuals can donate directly to groups seeking to use the funds. Individuals can also donate to foundations and charities. Such foundations and charities can directly provide the funds to groups that can use the funds. At times allocation review committees control such allocations.

Fundraising can be difficult and impersonal. Group heads are often unable to manage numerous individuals and such fundraising efforts can be disorganized. Allocation review committees need to have clear visibility into the direction that their funds are moving. Individuals often want to know that their donations “count.” Often the efforts of groups, charities, foundations, and individuals can be strained by the process of fundraising. Groups fail to receive donations that could have otherwise been used. Some individuals or foundations may not reach the groups that can use the funds because of the burdens of managing fundraising.

The foregoing examples of the related art and limitations related therewith are intended to be illustrative and not exclusive. Other limitations of the related art will become apparent upon a reading of the specification and a study of the drawings.

### SUMMARY

The following examples and aspects thereof are described and illustrated in conjunction with systems, tools, and methods that are meant to be exemplary and illustrative, not limiting in scope. In various examples, one or more of the above-described problems have been reduced or eliminated, while other examples are directed to other improvements.

Groups can be managed through a system providing a private interface to the group members and a public interface to individuals outside the group. Group members can provide information to a group record storage that can be managed by group members and a group head. A group knowledge management engine can govern the receipt, storage and retrieval of group information. A group knowledge search module can supply group information to group members and others having permission to view the information. Statistics of group successes in, e.g., fundraising can be calculated and provided to the group by the private interface as well as published to the public interface.

Various methods can be implemented to further the interests of the group. For example, methods can be implemented to collect information from group members, visualize relationships between groups, create a public or private group interface, visualize performance of a group, manage a group, highlight performance of a group, and otherwise organize group members.

### BRIEF DESCRIPTION OF THE DRAWINGS

FIG. 1 depicts an example of a system for managing group members.

FIG. 2 depicts an example of components of a group management engine.

FIG. 3 depicts a flowchart of an example of a method for collecting information from group members.

FIG. 4 depicts a flowchart of an example of a method for visualizing relationships between groups.

FIG. 5 depicts a flowchart of an example of a method for creating a group interface.

FIG. 6 depicts a flowchart of an example of a method for visualizing performance of a group.

FIG. 7 depicts a flowchart of an example of a method for managing a group of individuals.

FIG. 8 depicts a flowchart of an example of a method for highlighting performance of multiple groups.

FIG. 9 depicts an example of a computing system that is representative of the computing systems described herein.

FIG. 10 depicts a flowchart of an example of a method for organizing group members.

FIG. 11 depicts a screenshot of an example of a group registration page.

FIG. 12 depicts a screenshot of an example of a group profile page.

FIGS. 13A-B depicts screenshots of group member import pages.

FIG. 14 depicts a screenshot of a page offering group visualization.

FIG. 15 depicts a screenshot of a page for inviting group member profile activation.

FIGS. 16A-B depict screenshots of an individual within a group and the individual and his profile information after drilling down on the individual.

FIG. 17 depicts a screenshot of visualization of two groups associated by a group member of two groups.

FIGS. 18A-B depict screenshots of groups of groups related by a common member.

FIG. 19 depicts a common factor linking groups within a group.

FIG. 20 depicts a website of a group as created using templates and group information.

FIG. 21 depicts a screenshot of a page displaying group performance based on a variety of criteria.

FIGS. 22A-B depict screenshot of group performance relative to planning.

FIGS. 23A-B depict screenshots of exemplary pages of group fundraising performance over time, source location and amount of donation.

FIG. 24 depicts a template of a page that could be used to create a page with group information.

FIG. 25 depicts an example of a flowchart of a method for requesting funding using a public interface and a private interface.

FIG. 26 depicts a screenshot of an example of a knowledge management center displaying an implementation of widgets.

FIG. 27 depicts a screenshot of a knowledge management center displaying documents created by group members.

FIG. 28 depicts a screenshot of a flow diagram depicting a fundraising and fund allocation chain.

FIG. 29 depicts a screenshot of an example of an interface that can be used to request funds.

FIG. 30 depicts a screenshot of an example of an interface that can be used to define reasons for fundraising.

FIG. 31 depicts a screenshot of an example of an interface that can be used to provide supporting materials to a request for fundraising.

### DETAILED DESCRIPTION

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

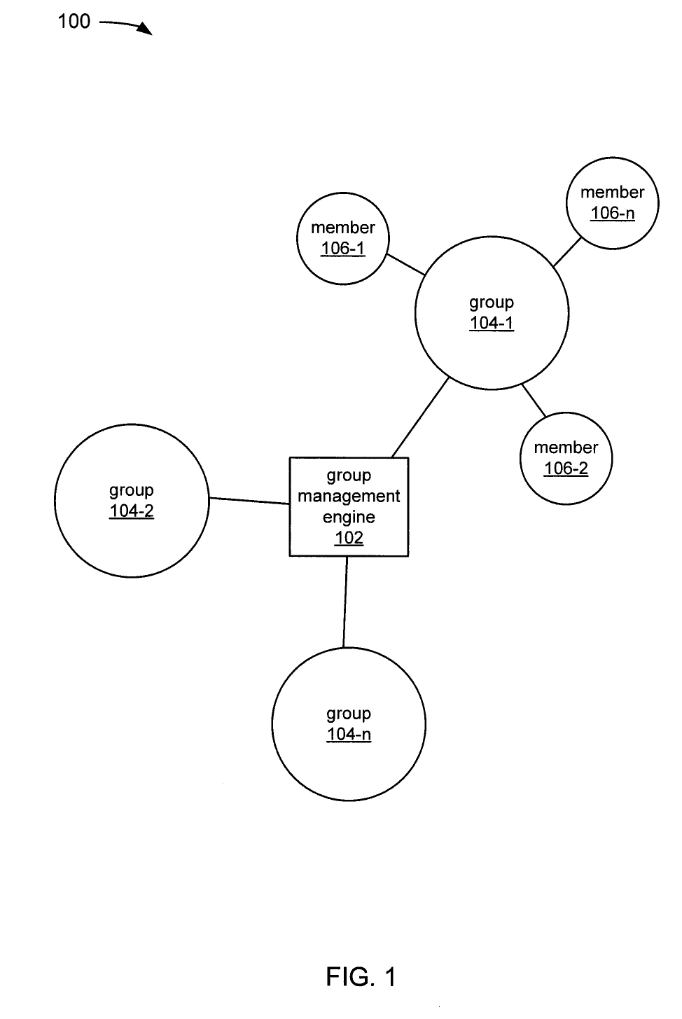

FIG. 1 depicts an example of a system 100 for managing group members. FIG. 1 includes group management engine 102, group 104-1, group 104-2, group 104-n (collectively groups 104), member 106-1, member 106-2, and member 106-n (collectively members 106).

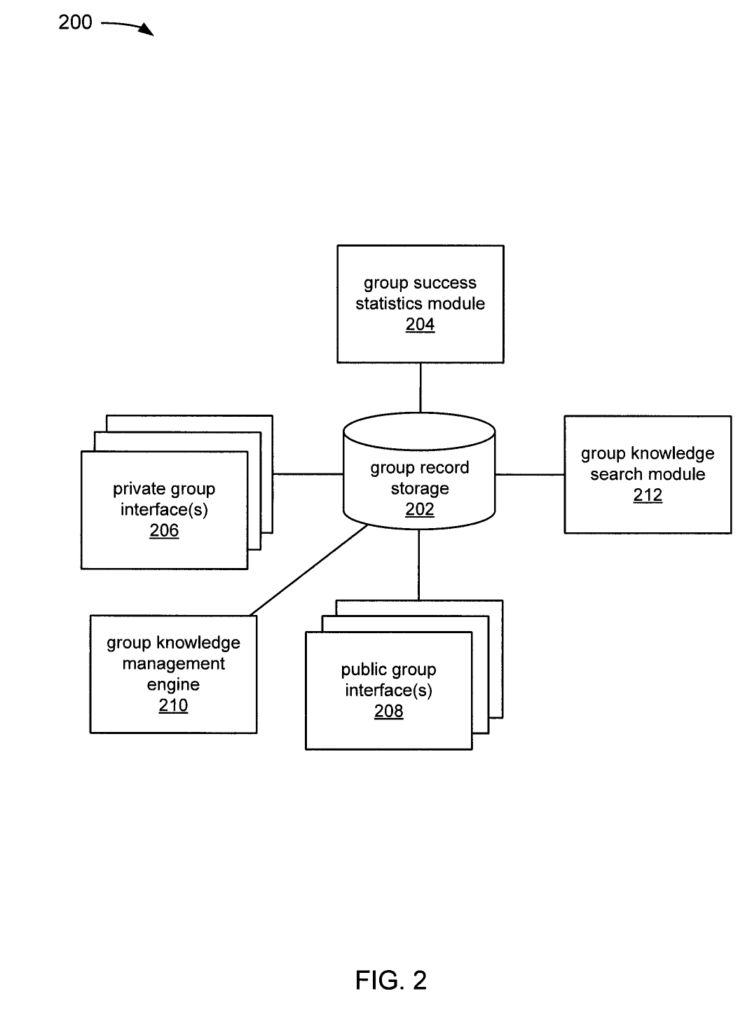

In the example of FIG. 1, group management engine 102 can include any computing combination of computing devices, such as more than one server class computing device networked together to provide data and information services. The group management engine 102 and modules included therein are discussed in further depth in reference to FIG. 2.

In the example of FIG. 1, the groups 104 include organizations, foundations, religious groups, political groups, corporate entities, and any known or convenient organizations. The members 106 can be individuals, legal entities, other groups, or any known or convenient entity or organization. While only one group is displayed as having members extending there from, each of groups 104 can have members, but such group members are hidden for clarity.

In the example of FIG. 1, in operation, the members 106 provide information, documents, requests, reports, and any other group related information to the group 104. The group management engine 102 organizes the information and produces various reports for internal and external group use. Statistics of group performance can be generated. Messages to group members can be transmitted and received.

A special type of member of members 106 can be a group head. There can be one or more group heads associated with a group 104. Group heads are typically given permission to manage the associated group including making changes to the group membership via the group management engine 102. In a non-limiting example, at times one of the members 106, acting as a group head, can request information from group members 106 via the group management engine 102. The received information can be stored in the group management engine 102 for group 104-1. Similarly, each group 104 can have one or more group heads administrating or managing the group.

FIG. 2 depicts examples of components 200 of group management engine, such as group management engine 102 as discussed in reference to FIG. 1. FIG. 2 includes group record storage 202, group success statistics module 204, private group interface(s) 206, public group interface(s) 208, group knowledge management engine 210, and group knowledge search module 212.

The group record storage 202 can be any database, data store, file, data structure, or other information management or storage unit. The group record storage 202 includes group information and can store and retrieve information for the group on behalf of group members.

The group success statistics module 204 operates to continuously update existing group performance by retrieving group records from the group record storage 202 and to analyze group performance in view of group planning. For example group performance can be measured as actual group performance relative to planned group performance. In a non-limiting example, group fundraising performance is determined by the group success statistics module 204 in reference to the planned group fundraising.

The private group interface(s) 206 can be a web interface, stand alone graphical user interface (GUI), special purposed computing device, or any other known or convenient device for displaying and receiving information. The private group interface(s) 206 both receive information from group members and provide information to group members. Individuals that are not registered with the group are unable to access the private group interface(s). For example, the private group interface(s) 206 can be protected by an authentication scheme, such as a user identifier/password system. Typically a group head controls the private group interface(s). In a non-limiting example, the private group interface 206 can include or be expressed as a website. The private group interfaces 206 can be used to receive search requests from individual group members.

The public group interface(s) 208 can be, as above, any known or convenient device for displaying and receiving information, including the devices discussed in reference to private group interface(s) 206. The public group interface(s) 208 can be accessible to individuals outside of the group. A group can make a public group interface available to all individuals outside the group, or alternatively access can be limited to certain other groups. In this way, criteria can be defined to determine whether or not to allow an individual to view the public group interface. For example, the criteria can be defined by the group head. The public group interfaces 208 can be used to receive search requests for group information. Such information can be specified as public by group members.

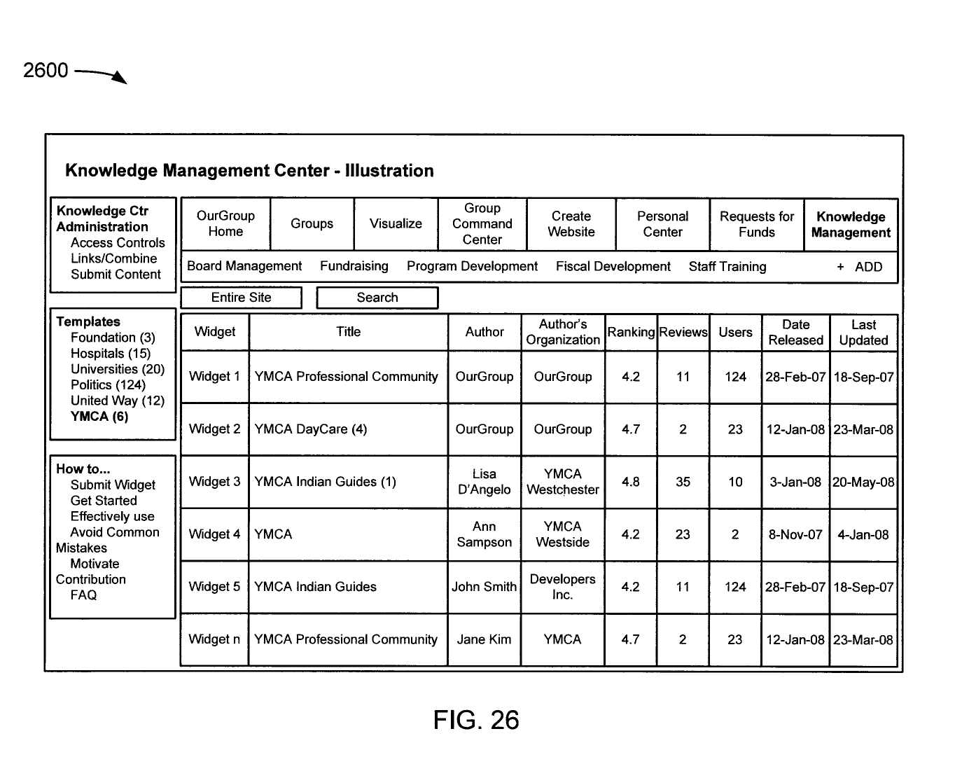

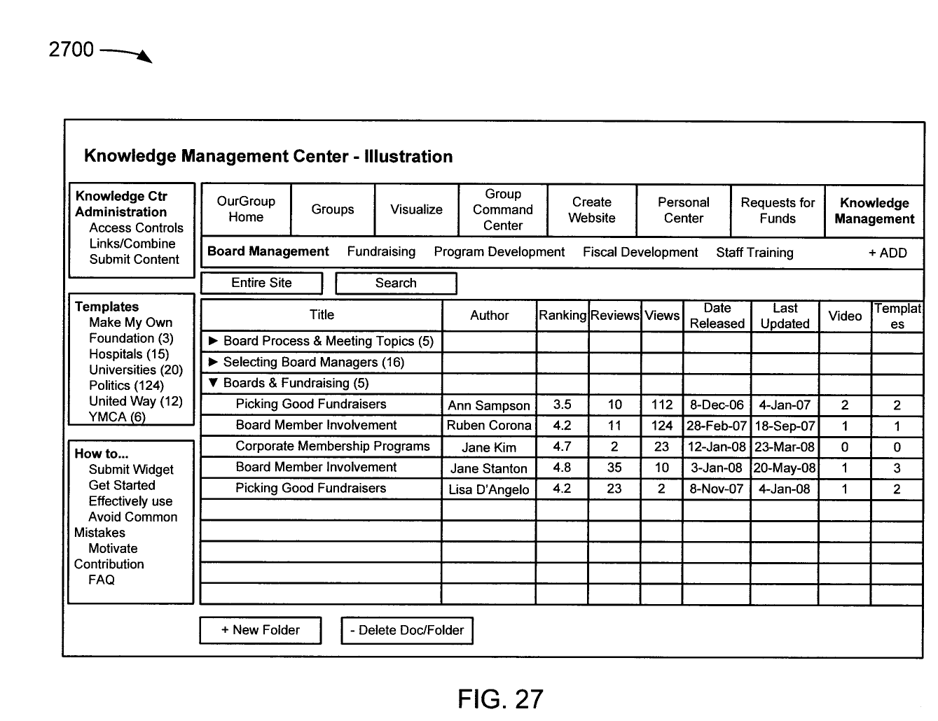

The group knowledge management engine 210 includes a variety of group management functionality, such as widgets, that can link or relate group information stored in the group record storage. Widgets can be knowledge management templates, designed to collect and display particular kinds of information or data. Widgets can be used for any type of information, and can collect and display information. For non-limiting examples of implementations including a knowledge management engine and widgets, please refer to FIG. 26 and FIG. 27. A group head can use the knowledge management engine 210 to collect and send information to and from members. Contact information of the individuals receiving and transmitting the information can be maintained in confidentiality, such as by concealing such contact information from either or both the group head and group members and exposing this information only to the group knowledge management engine 210 for transmission and receipt of communications.

The group knowledge search module 212 can be any search engine, function, and special-purpose computing device, software implementation embodied in a tangible computer readable medium, or other system or device operable to retrieve records including group knowledge. Responsive to a search request, the group knowledge search module 212 retrieves and displays relevant information from the group record storage 202.

In the example of FIG. 2 in operation, the private group interface(s) 206 receive information from group members and store the information in the group record storage 202. The private group interface(s) 206 can also retrieve information from the group record storage 202 and display such information. The group success and statistics module 204 can retrieve the information stored in the group record storage 202, for example, fundraising information, and compute the success of groups relative to their planned fundraising. Such data can be stored in the group record storage 202 and made available to group members by the private group interface(s) 206 and the public group interface(s) 208. Similarly, the public group interface(s) 208 can retrieve group information from the group record storage 202 and display the information to individuals having permission to view the public group interface(s) 208.

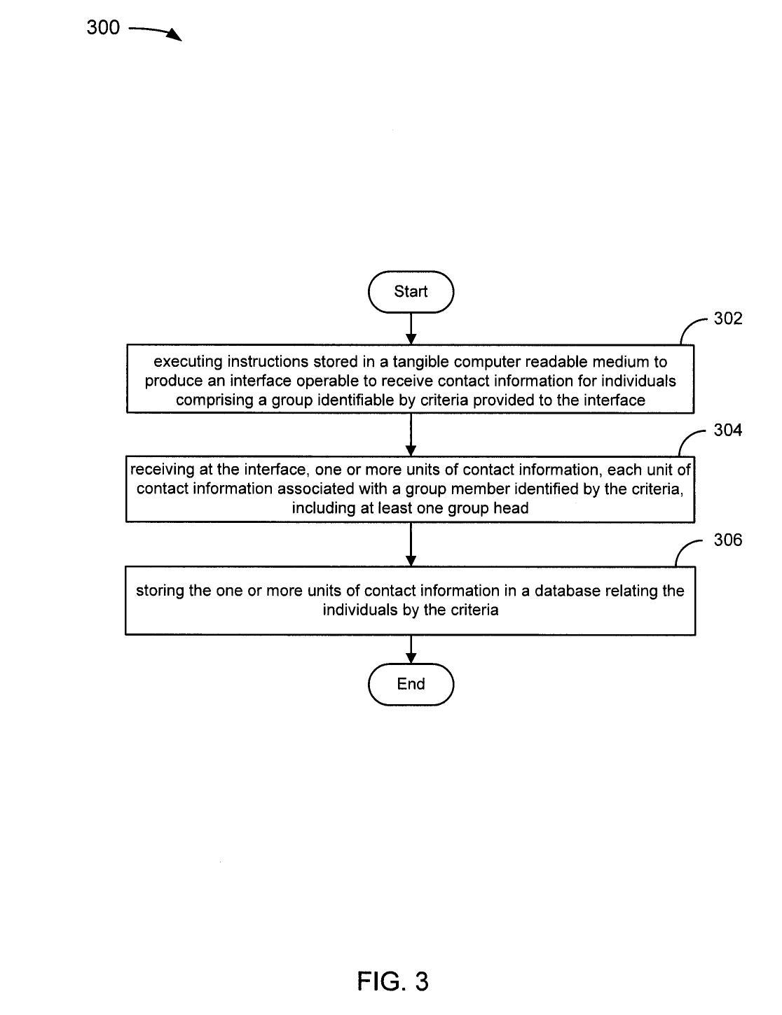

FIG. 3 depicts a flowchart 300 of an example of a method for collecting information from group members. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

In the example of FIG. 3, the flowchart begins at module 302 with executing instructions stored in a executing instructions stored in a tangible computer readable medium to produce an interface operable to receive contact information for individuals comprising a group identifiable by criteria provided to the interface. The interface can be any known or convenient system or device for collecting information from one or more individuals or entities. Typically, the interface is produced by executing the instructions on a computing device and the interface may be displayed on the same computing device, or on another computing device connected thereto by one or more networks. The criteria can include or be based on a common purpose of the group, for example, political, religious, environmental, educational, or any known or convenient factor commonly identifying the members of the group.

In the example of FIG. 3, the flowchart continues to module 304 with receiving at the interface, one or more units of contact information, each unit of contact information associated with a group member identified by the criteria, including at least one group head. The individual group members may enter their own information, manually or, in a non-limiting example, by v-card. Alternatively, a single member, such as the group head can enter some or all group member information one member at a time or in batches. The authenticity of an individual can be validated, such as by comparing units of contact information with known units of contact information. In another example, widgets can be used to collect information.

For visualization of a group member, colored lights can be used to indicate the status of the group member's profile. For example, authenticity of the individual's contact information can be indicated by displaying, for example, a colored light bulb above an image representing the individual, e.g., green. Similarly, the failed authentication can be indicated by a light of a different color, for example, red. Additionally, a failure to have collected contact information can be indicated, for example by displaying a yellow light. Also, an inactive profile can be indicated by, for example, a grey light. In one example, the individual's contact information can be authenticating by requesting the individual's credit card information.

In the example of FIG. 3, the flowchart continues to module 306 with storing the one or more units of contact information in a database relating the individuals by the criteria. The database can be a common information repository for the group, and may be a section of a database holding information for many groups, wherein each group is associated with a section. Having stored the one or more units of contact information, the flowchart terminates.

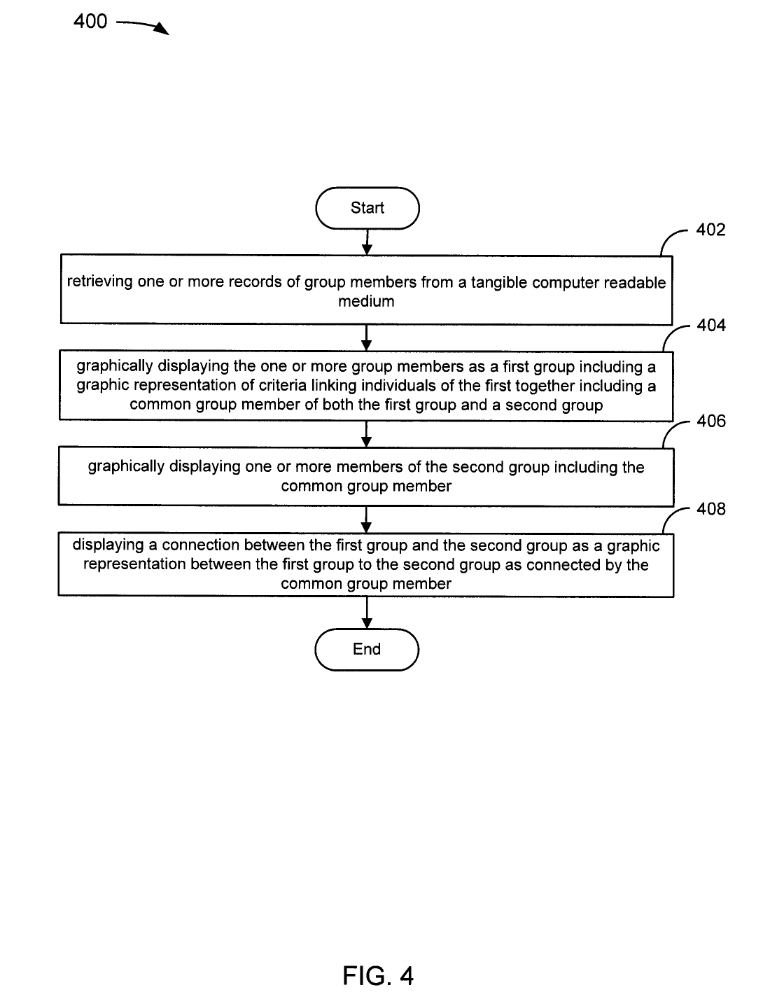

FIG. 4 depicts a flowchart 400 of an example of a method for visualizing relationships between groups. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

In the example of FIG. 4, the flowchart begins at module 402 with retrieving one or more records of group members from a tangible computer readable medium. The records can be records of group members stored in a database including the member's information. The information can include description of the group in terms of sub-groups and members thereof.

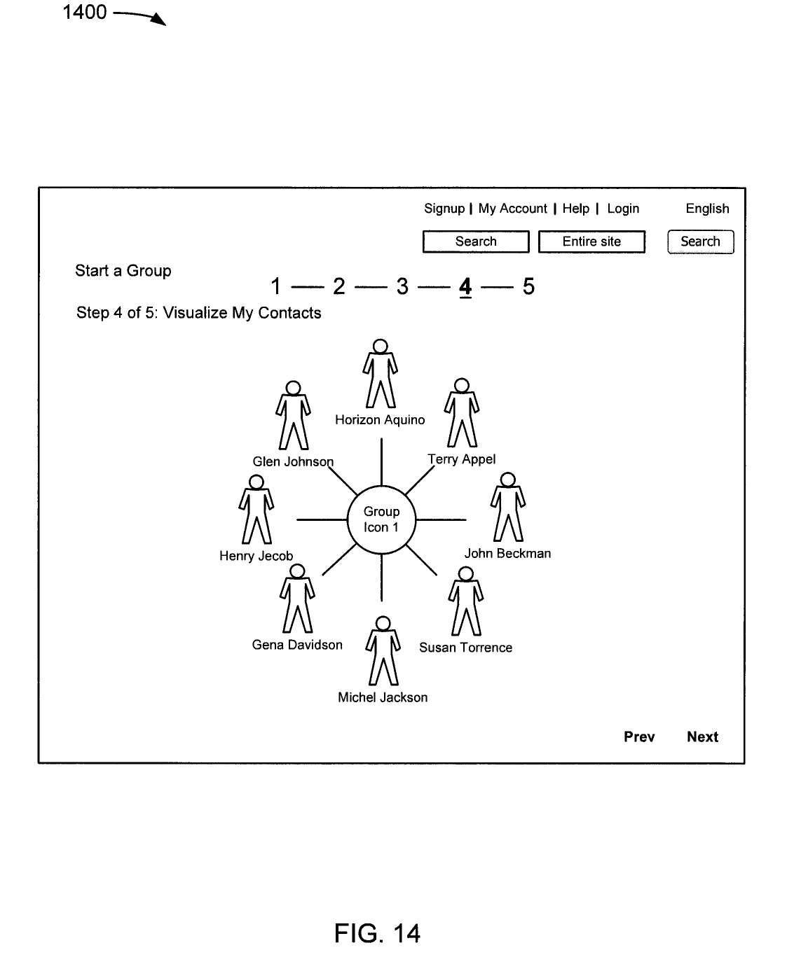

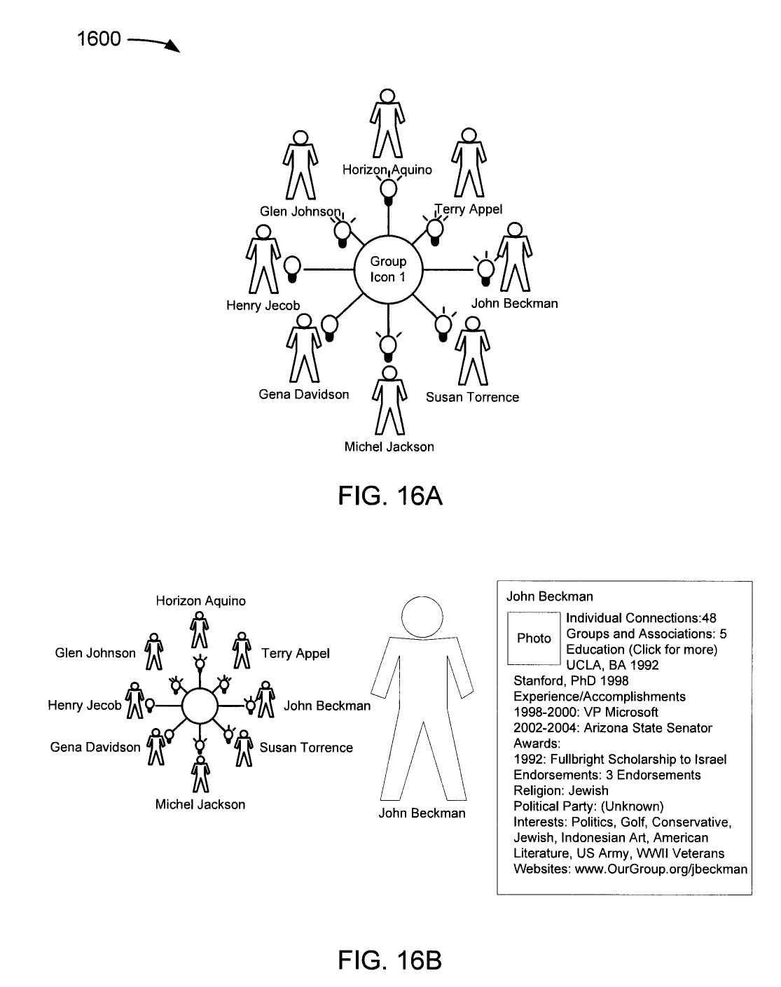

In the example of FIG. 4, the flowchart continues to module 404 with graphically displaying the one or more group members as a first group including a graphic representation of criteria linking individuals of the first together including a common group member of both the first group and a second group. A non-limiting example of a page created in this regard can be FIG. 14; similarly other non-limiting examples of group visualization can be found in FIGS. 16, 17, 18, and 19. Typically the group members are linked together around a symbol representing a concept or idea the individuals share, such as a charity or cause.

In the example of FIG. 4, the flowchart continues to module 406 with graphically displaying one or more members of the second group including the common group member. The members of the second group can be displayed in a manner similar to that of the first group.

In the example of FIG. 4, the flowchart continues to module 408 with displaying a connection between the first group and the second group as a graphic representation between the first group and the second group as connected by the common group member. The graphic representation can bring to mind the relationship between the groups visually to allow rapid identification of the common member between the groups. Such a link can be used by the groups to manage relationships between the groups and collaborate on projects as well as further common goals between the groups. Having displayed a connection between the first group and the second group, the flowchart terminates.

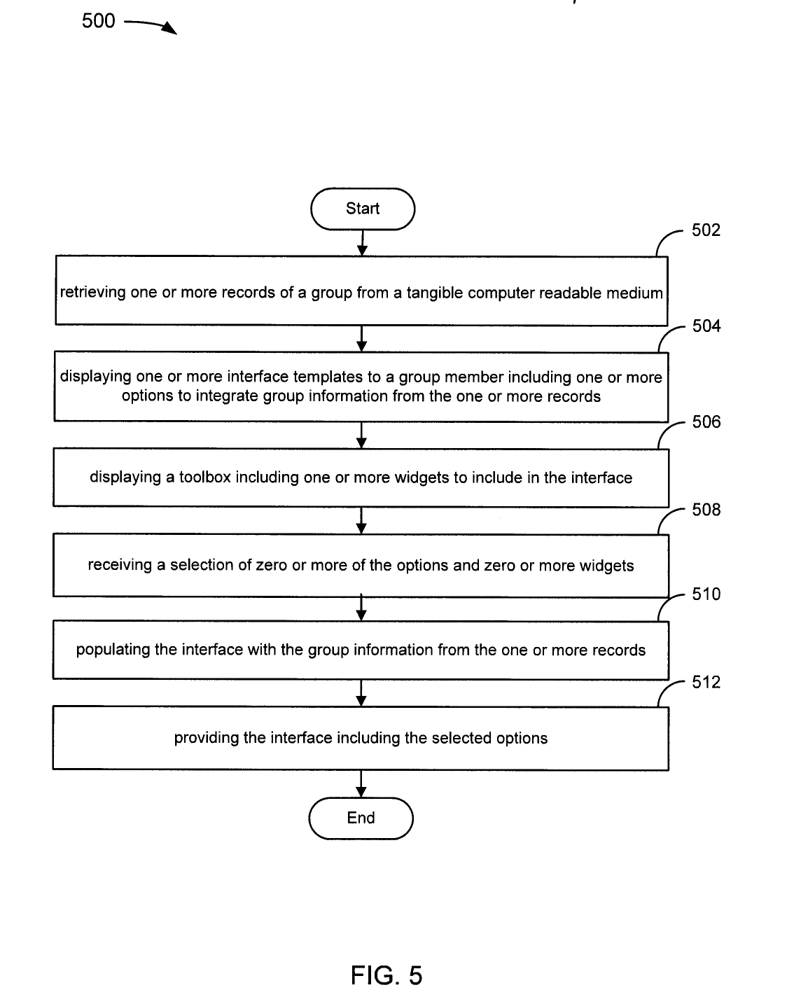

FIG. 5 depicts a flowchart 500 of an example of a method for creating a group interface. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

In the example of FIG. 5, the flowchart begins at module 502 with retrieving one or more records of a group from a tangible computer readable medium. The interface can be public or private. Such records can include information about the group that the group desires to make available. For example, the information can be shared to promote the group's ideals and values to others, or alternatively, the information can be used by the group members for private purposes, such as to manage the group.

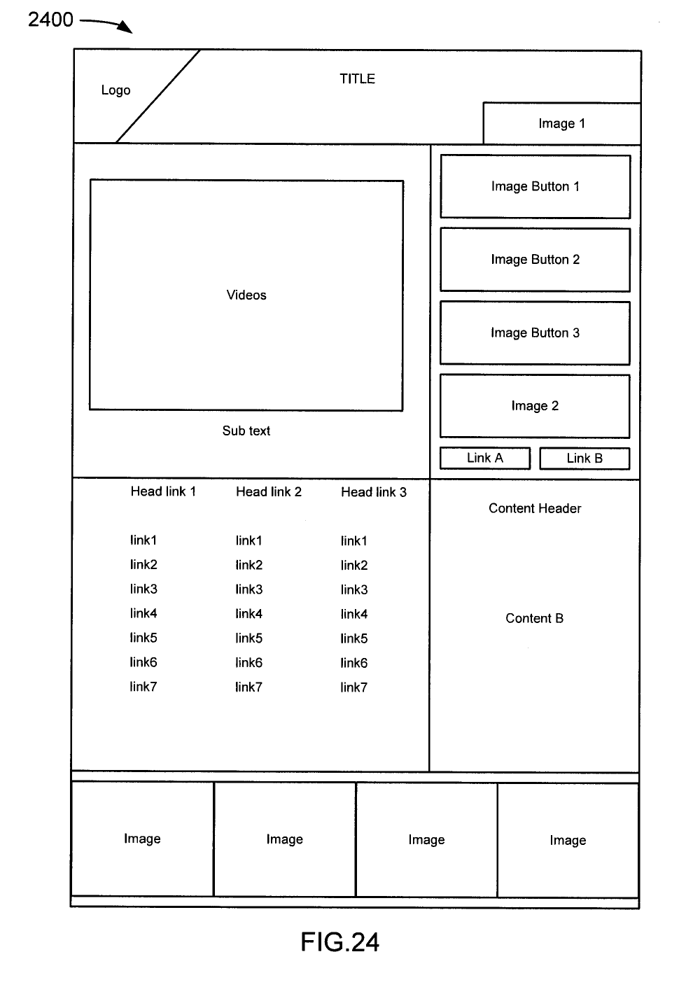

In the example of FIG. 5, the flowchart continues to module 504 with displaying one or more interface templates to a group member including one or more options to integrate group information from the one or more records. The templates can be standardized to include one or more fixed locations, each displaying a specific type of information. A non-limiting example of a template of a page is included in FIG. 24. Options can also be standardized, however, when implemented by the group head or group members, the options can be used in different ways to make radically different interfaces. The group information can be linked to the template, for example, via the options, in order to populate the interface with group information.

In the example of FIG. 5, the flowchart continues to module 506 with displaying a toolbox including one or more widgets to include in the interface. The widgets can be selected by the group head or group member creating the interface to perform basic web application functionality such as to transmit messages to group members via the interface. Such widgets can be highly interactive, and can both populate themselves with information from the group as well as serve as a source of input from group members. For example, a survey widget could be included in the interface to poll group members on a given topic of interest to the group.

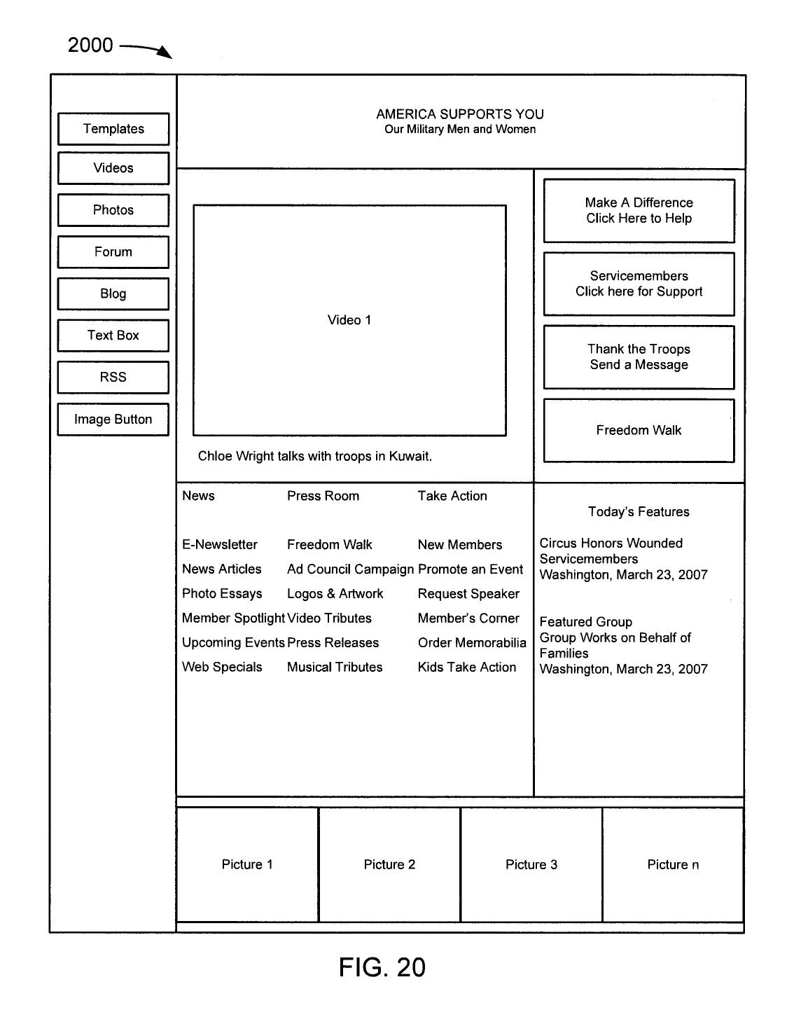

In the example of FIG. 5, the flowchart continues to module 508 with receiving a selection of zero or more of the options and zero or more widgets. The group head or group member places the widgets and options throughout the interface and can fill out the interface. A non-limiting example of such an interface is a web page as depicted in FIG. 20.

In the example of FIG. 5, the flowchart continues to module 510 with populating the interface with the group information from the one or more records. The options and widgets can display the group information they are linked to, for example, the names and contact information for group members can be inserted into the interface along with titles, pictures and other group information. The populated interface can appear as through specifically designed for the group. Having populated the interface with the group information, the flowchart terminates.

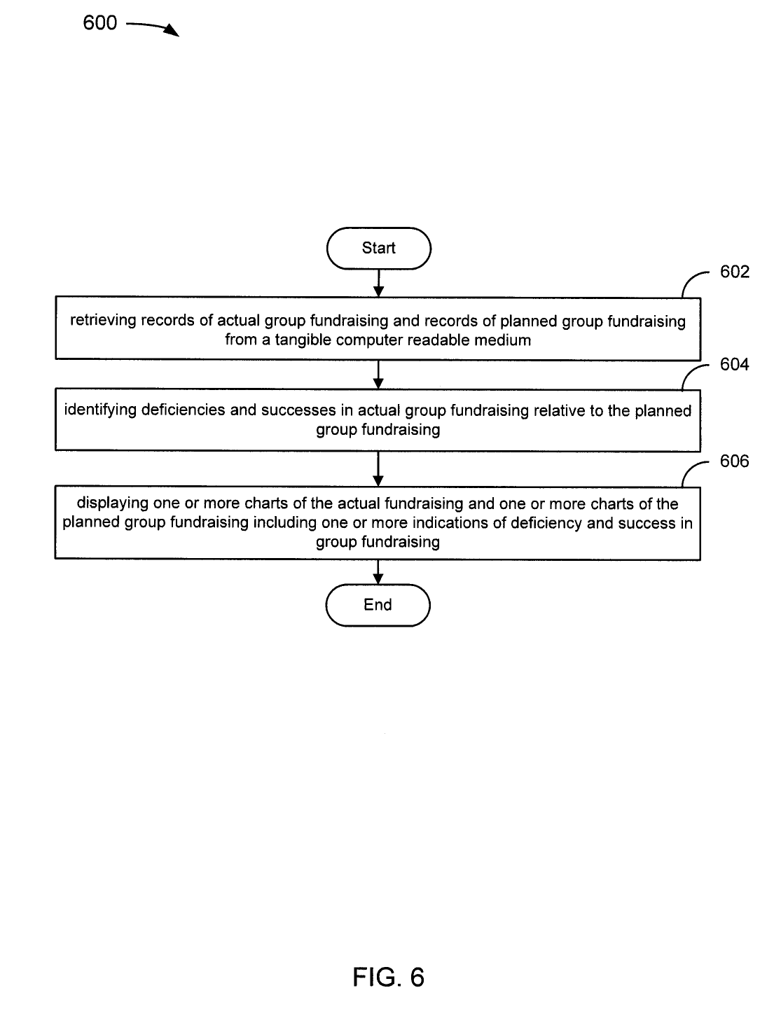

FIG. 6 depicts a flowchart 600 of an example of a method for visualizing performance of a group. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

In the example of FIG. 6, the flowchart begins at module 602 with retrieving records of actual group fundraising and records of planned group fundraising from a tangible computer readable medium. The planned group fundraising can be an ideal case or estimated, such as goals and sub-goals for a group over time, whereas the actual group fundraising includes the donations received by the group. The relationship of planned to actual can differ substantially, such as where the group has had a particularly good or bad year in fundraising.

In the example of FIG. 6, the flowchart continues to module 604 with identifying deficiencies and successes in actual group fundraising relative to the planned group fundraising. Such deficiencies and successes can be identified by summing donations over a period of time and correlating the sum with a similar sum of the planned group fundraising. Where the planned fundraising is higher than the donations, the donations can be said to be deficient relative to the planned amounts. Similarly, where the planned fundraising is lower than the donations, it can be said that there was success in fundraising.

In the example of FIG. 6, the flowchart continues to module 606 with displaying one or more charts of the actual fundraising and one or more charts of the planned group fundraising including one or more indications of deficiency and success in group fundraising. The donations can be displayed along with the planned fundraising over time to indicate the points and times at which the group was particularly successful or deficient. The group members responsible for the fundraising can be identified, either specifically, or by, e.g., geographic region, demographic, affiliation, or other factor. Having displayed one or more charts of the actual fundraising and one or more charts of the planned group fundraising, the flowchart terminates.

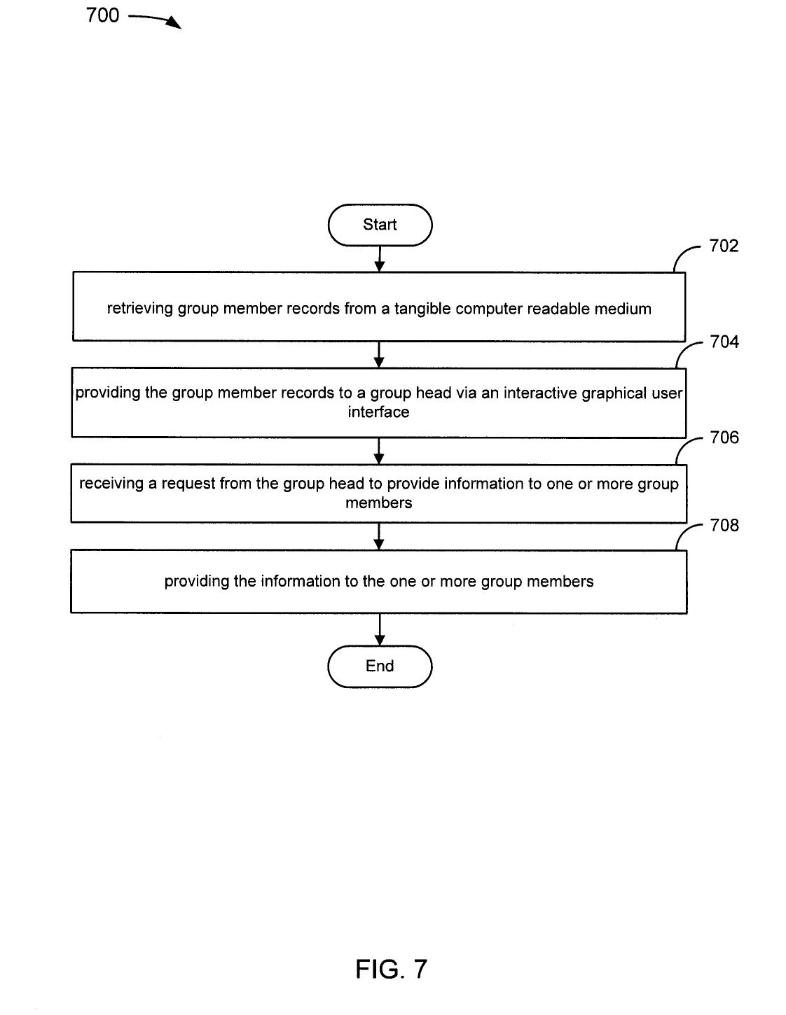

FIG. 7 depicts a flowchart 700 of an example of a method for managing a group of individuals. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

In the example of FIG. 7, the flowchart starts at module 702 with retrieving group member records from a tangible computer readable medium. The group member records can include, for example, contact information and group affiliation as well as any prior history the member has had in the group.

In the example of FIG. 7, the flowchart continues to module 704 with providing the group member records to a group head via an interactive graphical user interface. The information retrieved can be organized, for example, by member name, or other categorizing factor. Options can be provided to, for example, contact the member, remove the member from the group, or perform other management tasks related to the member.

In the example of FIG. 7, the flowchart continues to module 706 with receiving a request from the group head to provide information to one or more group members. The request can be tailored to identify many group members or a single group member to receive the information. The information can include a request for the group members to respond to, for example, a request for donations.

In the example of FIG. 7, the flowchart continues to module 708 with providing the information to the one or more group members. Such information can be delivered to the group members by an interface such as by notification that the individual has received a message and should retrieve the message from the group interface. Having provided the information to the one or more group members, the flowchart terminates.

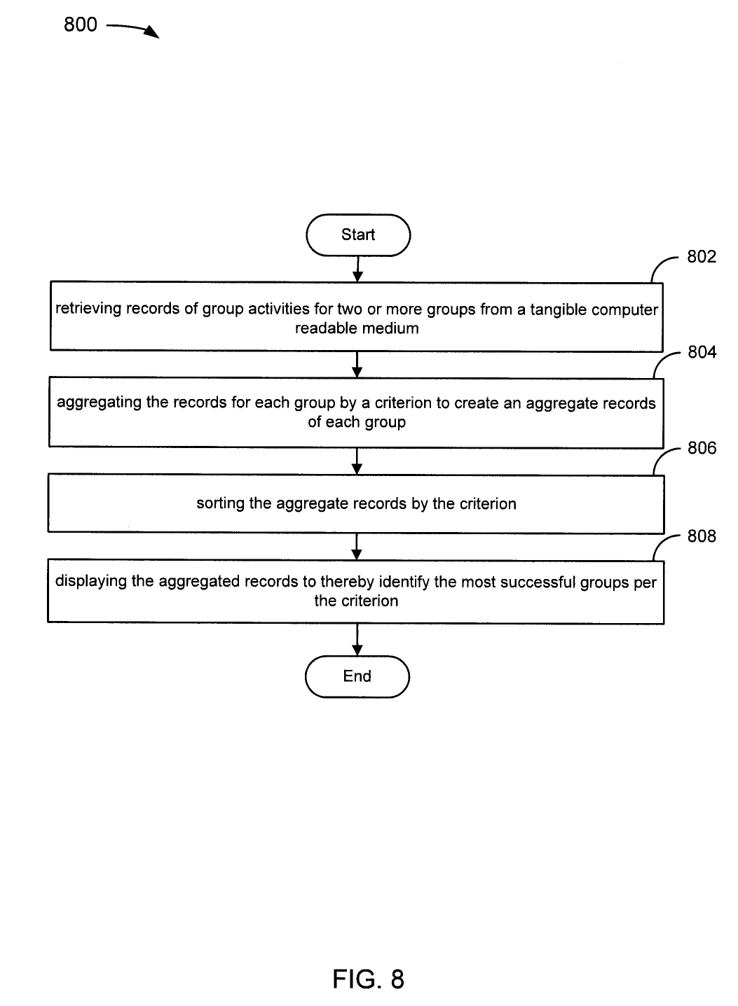

FIG. 8 depicts a flowchart 800 of an example of a method for highlighting performance of multiple groups. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

In the example of FIG. 8, the flowchart starts at module 802 with retrieving records of group activities for two or more groups from a tangible computer readable medium. The two or more groups can be involved in similar activities, for example, fundraising. The groups can be compared on a variety of factors for example, size, ranking, or any other comparable factor that could be used to compare groups. Any portion of a group interface or the group itself can be ranked, such as group blogs, groups overall, fundraising, or any other aspect or feature of a group. Group videos can be specified as the criteria on which to compare groups, such as by comparing rankings or quantities of group videos. Categories of groups can be broken down such as by type of group, for example, health, environment, politics and religion.

In the example of FIG. 8, the flowchart continues to module 804 aggregating the records for each group by a criterion to create aggregate records of each group. Aggregation of the records can be accomplished over time, for example, to determine the highest rated group over the most recent week. Alternatively, the aggregation can be completed continuously, so as to provide a constantly updated value by factor for the groups.

In the example of FIG. 8, the flowchart continues to module 806 sorting the aggregate records by the criterion. Groups can be organized in descending or ascending order, so as to find the highest and lowest rated group by factor.

In the example of FIG. 8, the flowchart continues to module 808 with displaying the aggregated records to thereby identify the most successful groups per the criterion. The display of the highest rated groups can be visual, including a breakdown of the group's performance over time, and over multiple factors such as by geographic location over time. Such breakdowns could be used to compare various sub-groups of a group. Having displaying the aggregated records, the flowchart terminates.

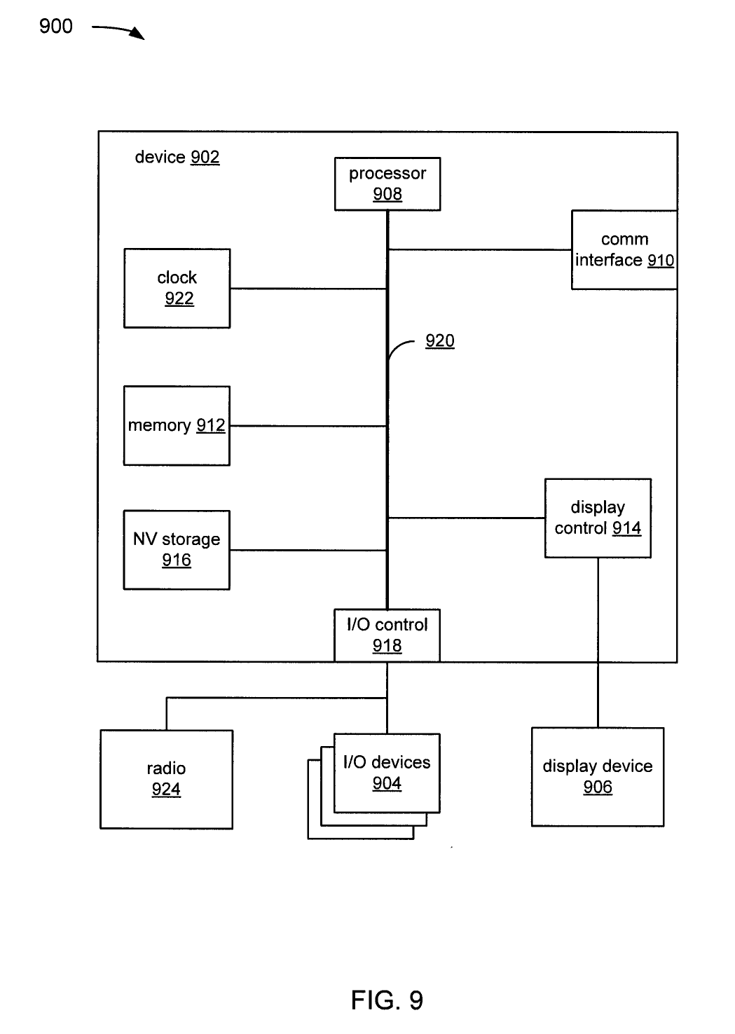

FIG. 9 depicts an example of a computing system that is representative of the computing systems described herein. The system 900 may be a conventional computer system that can be used as a client computer system, such as a wireless client or a workstation, or a server computer system. The system 900 includes a device 902, I/O devices 904, and a display device 906. The device 902 includes a processor 908, a communications interface 910, memory 912, display controller 914, non-volatile storage 916, I/O controller 918, clock 922, and radio 924. The device 902 may be coupled to or include the I/O devices 904 and the display device 906.

The device 902 interfaces to external systems through the communications interface 910, which may include a modem or network interface. It will be appreciated that the communications interface 910 can be considered to be part of the system 900 or a part of the device 902. The communications interface 910 can be an analog modem, ISDN modem or terminal adapter, cable modem, token ring IEEE 802.5 interface, Ethernet/IEEE 802.3 interface, wireless 802.11 interface, satellite transmission interface (e.g. “direct PC”), WiMAX/IEEE 802.16 interface, Bluetooth interface, cellular/mobile phone interface, third generation (3G) mobile phone interface, code division multiple access (CDMA) interface, Evolution-Data Optimized (EVDO) interface, general packet radio service (GPRS) interface, Enhanced GPRS (EDGE/EGPRS), High-Speed Downlink Packet Access (HSPDA) interface, or other interfaces for coupling a computer system to other computer systems over a network.

The processor 908 may be, for example, a conventional microprocessor such as an Intel Pentium microprocessor or Motorola Power PC microprocessor. The memory 912 is coupled to the processor 908 by a bus 920. The memory 912 can be Dynamic Random Access Memory (DRAM) and can also include Static RAM (SRAM). The bus 920 couples the processor 908 to the memory 912, also to the non-volatile storage 916, to the display controller 914, and to the I/O controller 918.

The I/O devices 904 can include a keyboard, disk drives, printers, a scanner, and other input and output devices, including a mouse or other pointing device. The display controller 914 may control images and text or other displayed items on the display device 906, which can be, for example, a cathode ray tube (CRT) or liquid crystal display (LCD). The display controller 914 and the I/O controller 918 can be implemented with conventional well known technology.

The non-volatile storage 916 is often a magnetic hard disk, flash memory, an optical disk, or another form of storage for large amounts of data. Some of this data is often written, by a direct memory access process, into memory 912 during execution of software in the device 902. One of skill in the art will immediately recognize that the terms “machine-readable medium” or “computer-readable medium” includes any type of storage device that is accessible by the processor 908.

Clock 922 can be any kind of oscillating circuit creating an electrical signal with a precise frequency or other device for tracking time. In a non-limiting example, clock 922 could be a crystal oscillator using the mechanical resonance of vibrating crystal to generate the electrical signal.

The radio 924 can include any combination of electronic components, for example, transistors, resistors and capacitors. The radio is operable to transmit and/or receive signals.

The system 900 is one example of many possible computer systems which have different architectures. For example, personal computers based on an Intel microprocessor often have multiple buses, one of which can be an I/O bus for the peripherals and one that directly connects the processor 908 and the memory 912 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 912 for execution by the processor 908. A Web TV system, which is known in the art, is also considered to be a computer system, but it may lack some of the features shown in FIG. 9, such as certain input or output devices. A typical computer system will usually include at least a processor, memory, and a bus coupling the memory to the processor.

In addition, the system 900 is controlled by operating system software which includes a file management system, such as a disk operating system, which is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 916 and causes the processor 908 to execute the various acts required by the operating system to input and output data and to store data in memory, including storing files on the non-volatile storage 916.

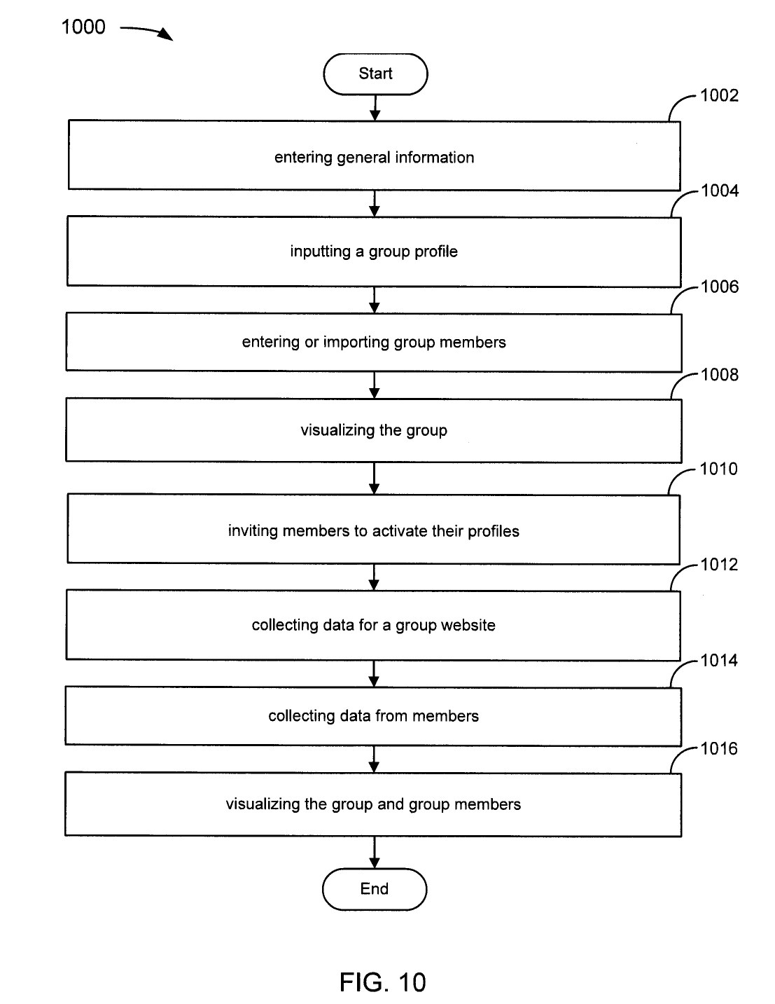

FIG. 10 depicts a flowchart 1000 of an example of a method for collecting group information in starting a group. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

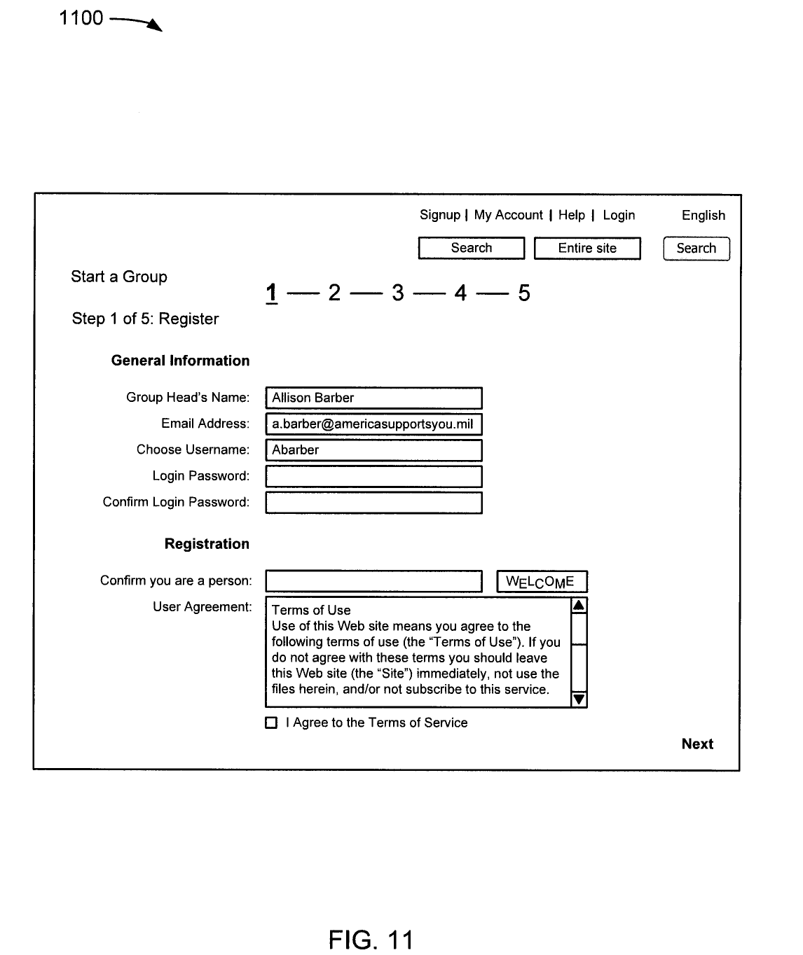

In the example of FIG. 10, the flowchart starts at module 1002 with entering general information. General information may include a group head name, an email address, username, password, a confirmation that the person applying is a person rather than a computer program e.g. type in a word from an image that cannot be machine read, and a user agreement. In a non-limiting example FIG. 11 displays an image of a page that could be used to enter general information.

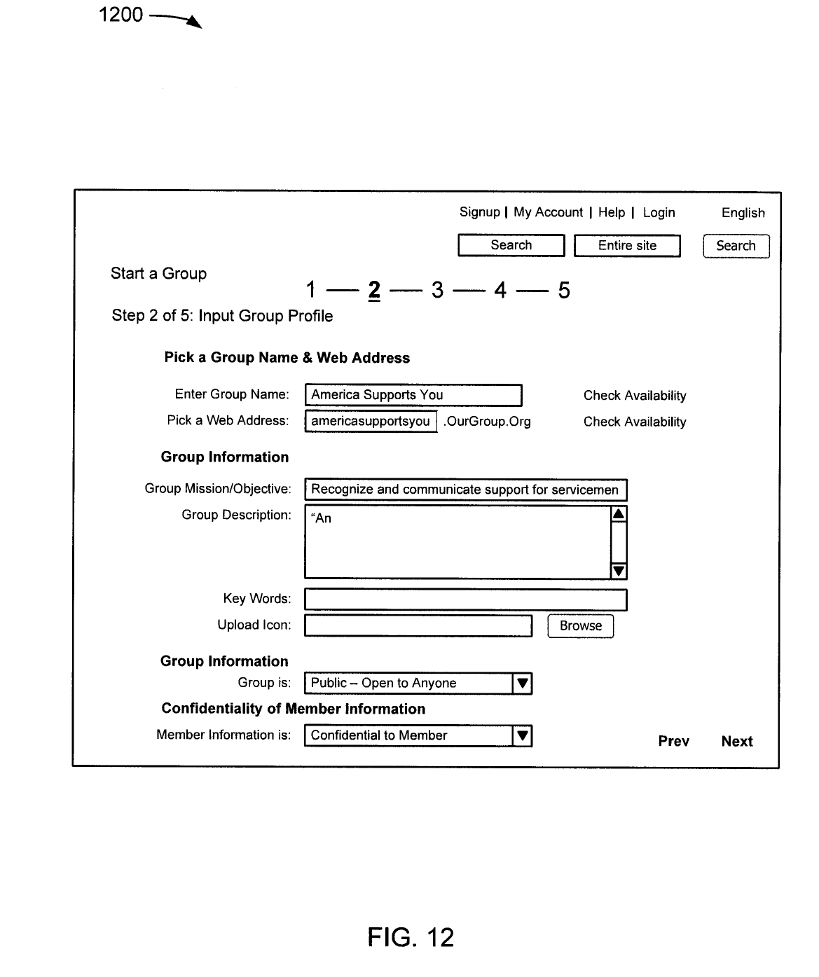

In the example of FIG. 10, the flowchart continues to module 1004 with inputting a group profile, which may include picking a group name, web address, group objective(s), group description, key words, group icon, membership criteria, and confidentiality of member information. For example, the web address can extend as webaddress.ourgroup.org. In a non-limiting example, FIG. 12 displays an image of a page that could be used to input a group profile.

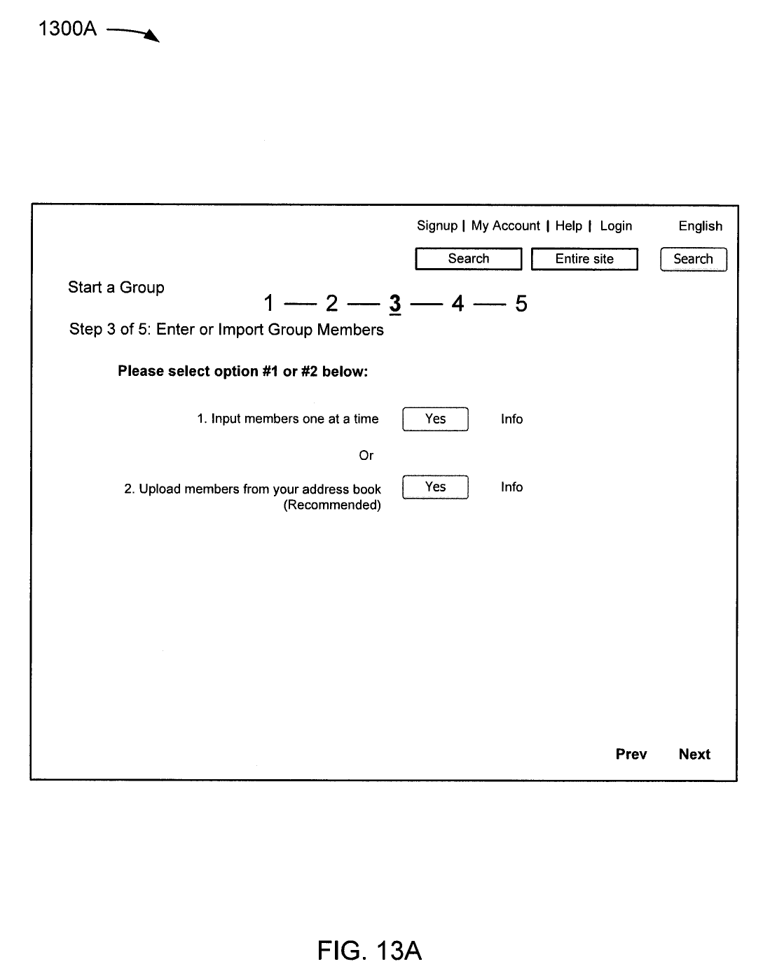

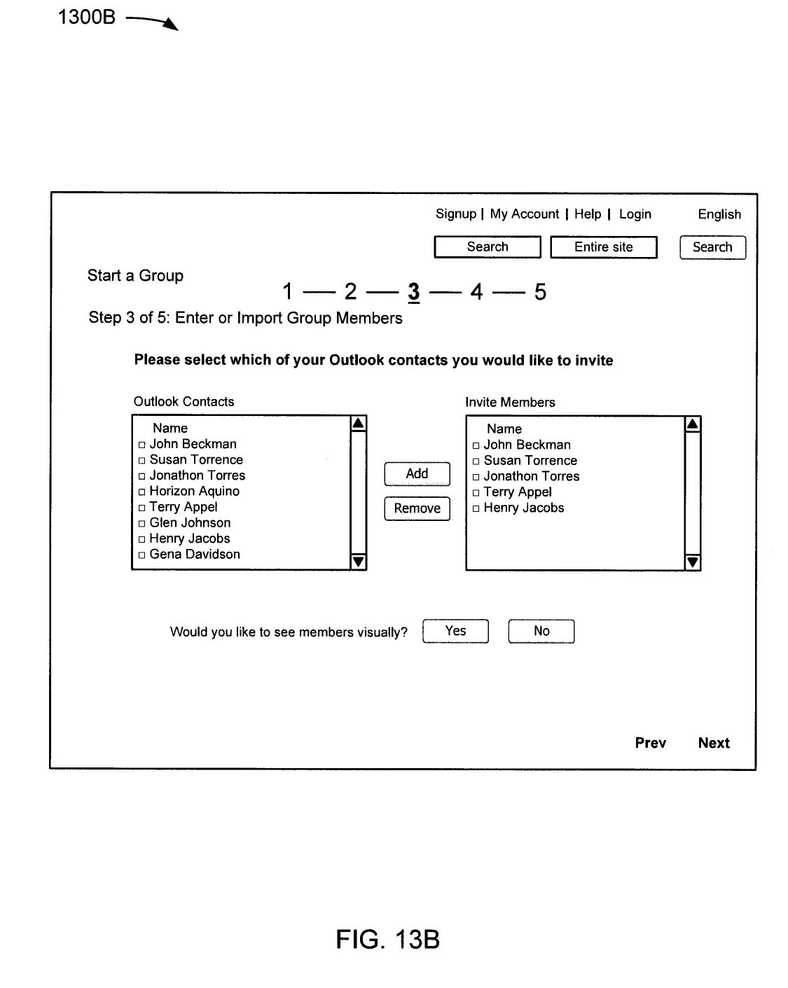

In the example of FIG. 10, the flowchart continues to module 1006 with entering or importing group contact information. The user may type in information or, in a non-limiting example, import contacts from a third-party program such as Microsoft Outlook® using an application programmer interface (API) for importing contacts. FIG. 13A-B display non-limiting examples of pages that could be used to enter or import group contact information. FIG. 13A displays a page that can be used to decide between options such as whether to enter contact information or to import contacts. FIG. 13B displays an image of selecting contacts from Outlook.

In the example of FIG. 10, the flowchart continues to module 1008 with visualizing the group. In a non-limiting example, FIG. 14 displays a group as visualized by centralizing a group icon and locating individual members around the group icon with lines connecting the individual members to the group icon.

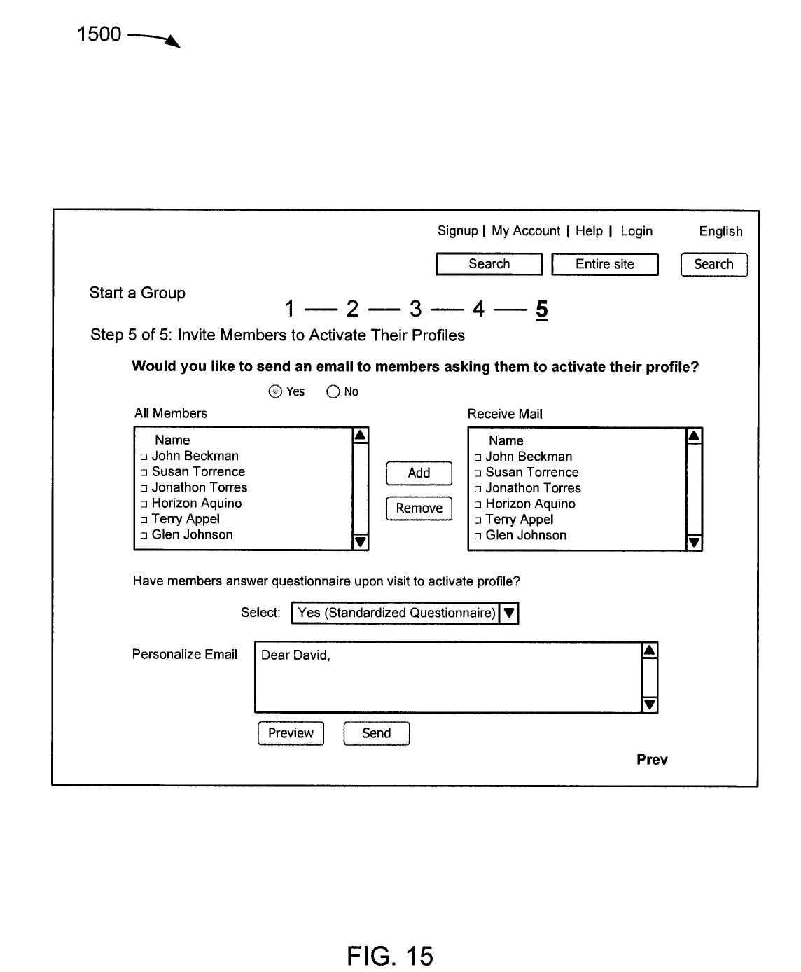

In the example of FIG. 10, the flowchart continues to module 1010 with inviting members to activate their profiles. In an illustrative embodiment, the group members are emailed invitations, such as by creating a message and delivering it to each member's email account. In a non-limiting example, FIG. 15 displays an image of a page for inviting members to activate their profiles.

In the example of FIG. 10, the flowchart continues to module 1012 with collecting data for a website. In an illustrative embodiment a user drags and drops data using an AJAX style website. Examples of data to drag and drop are photos, blogs, text boxes, RSS feed, and video clips. In a non-limiting example, FIG. 20 displays a page which can receive drag and drop data.

In the example of FIG. 10, the flowchart continues to module 1014 with collecting data from members. This data includes specific individual information describing the member e.g. education, employment, religion, political affiliation, contact information, interests, personal website etc.

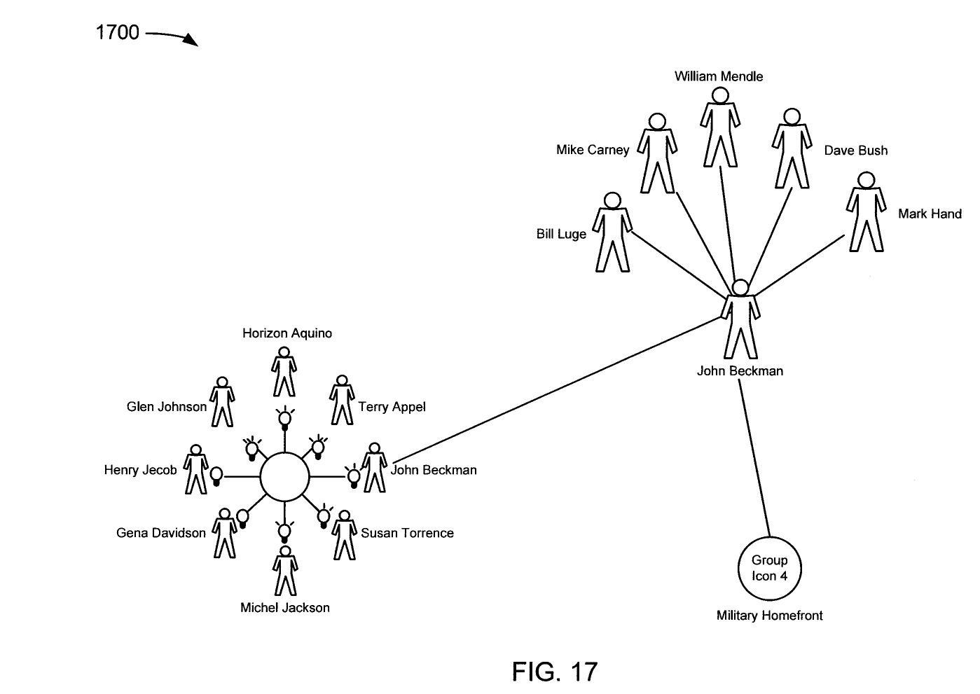

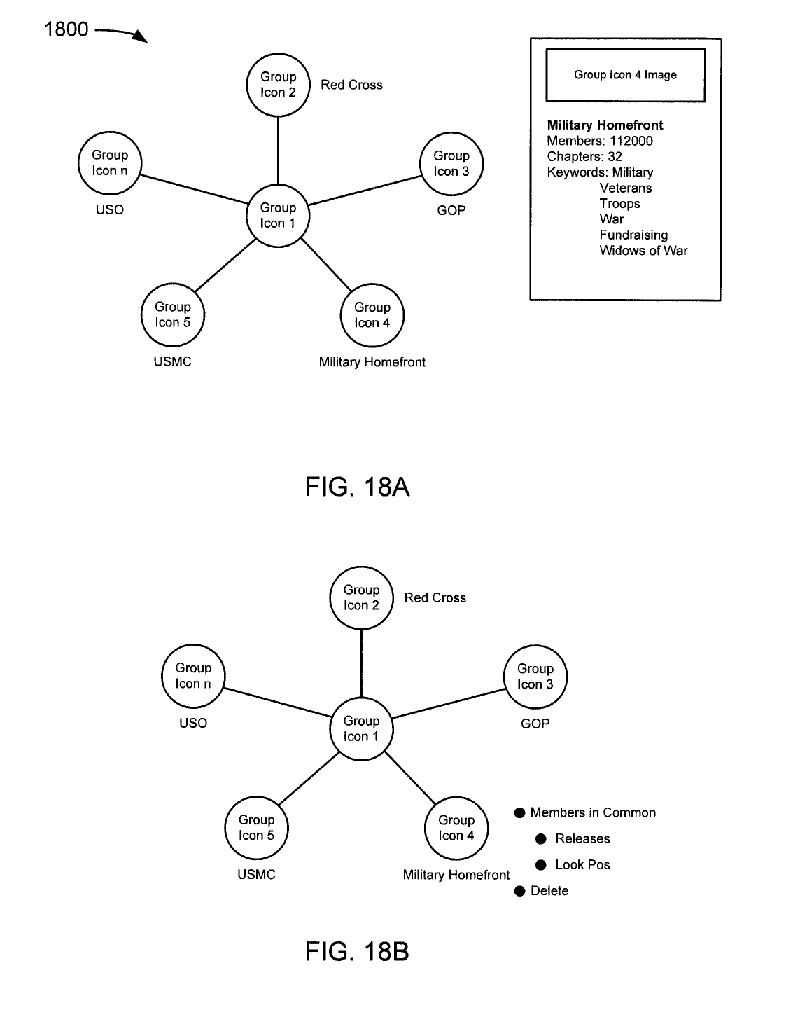

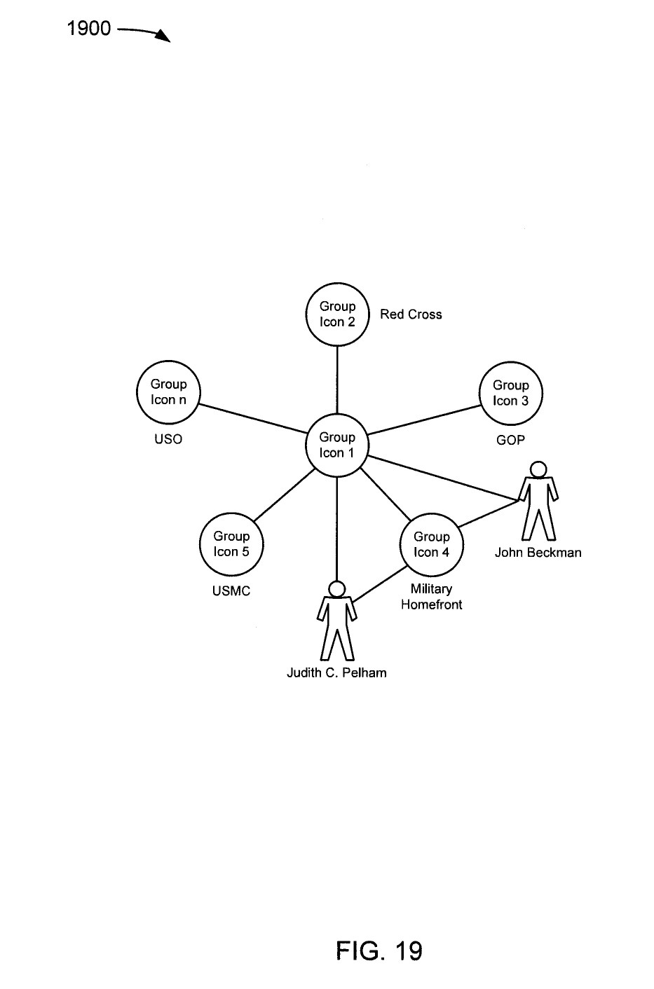

In the example of FIG. 10, the flowchart continues to module 1016 with visualizing the group. Although there are numerous ways to display the present data, the following specific non-limiting examples are provided for clarity. In a non-limiting example, FIG. 16A-B display pages of a group. Yellow lights indicate individuals that have joined the system and activated profiles. Un-lit lights indicate individuals that have not joined the system and activated their profiles. In FIG. 16A, a user may drill down (interact with a page, such as by clicking) on an individual in the group to identify profile information about the individual. FIG. 16B displays an individual and his profile information after drilling down on the individual. Further, FIG. 17 displays an example of a page depicting visualization of group associations as linked by the individual discussed in reference to FIG. 16B. The Individual is a link between two groups, and the visualization displays both groups and the links to identify groups and their relationships. FIG. 18A-B and FIG. 19 depict groups and their relationships.

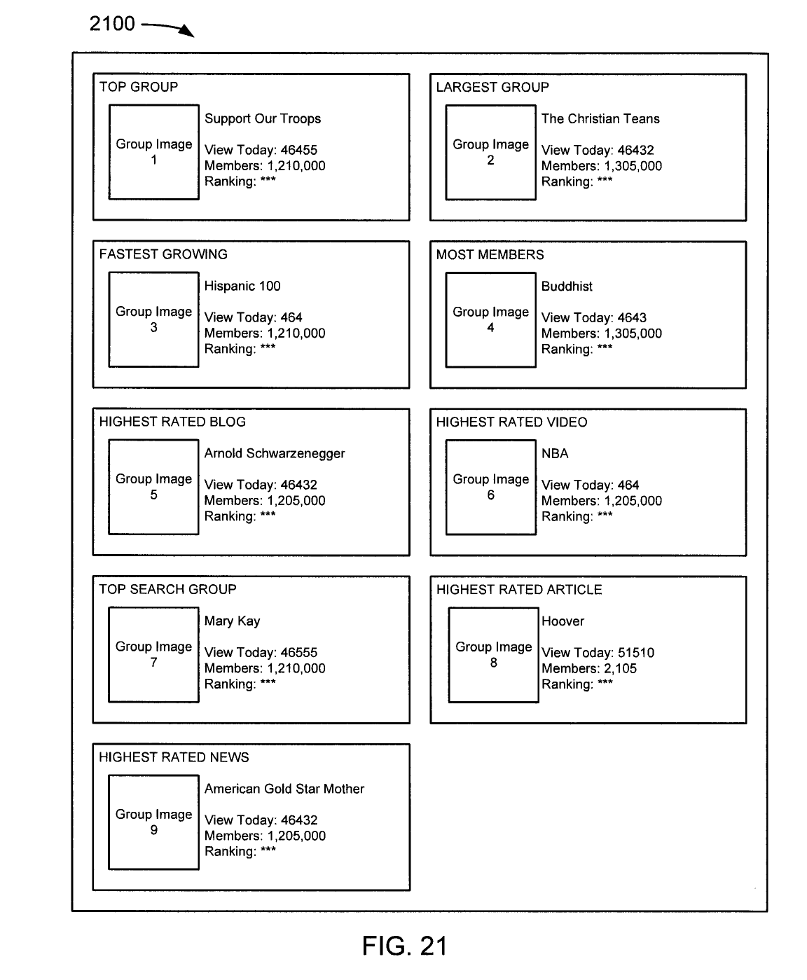

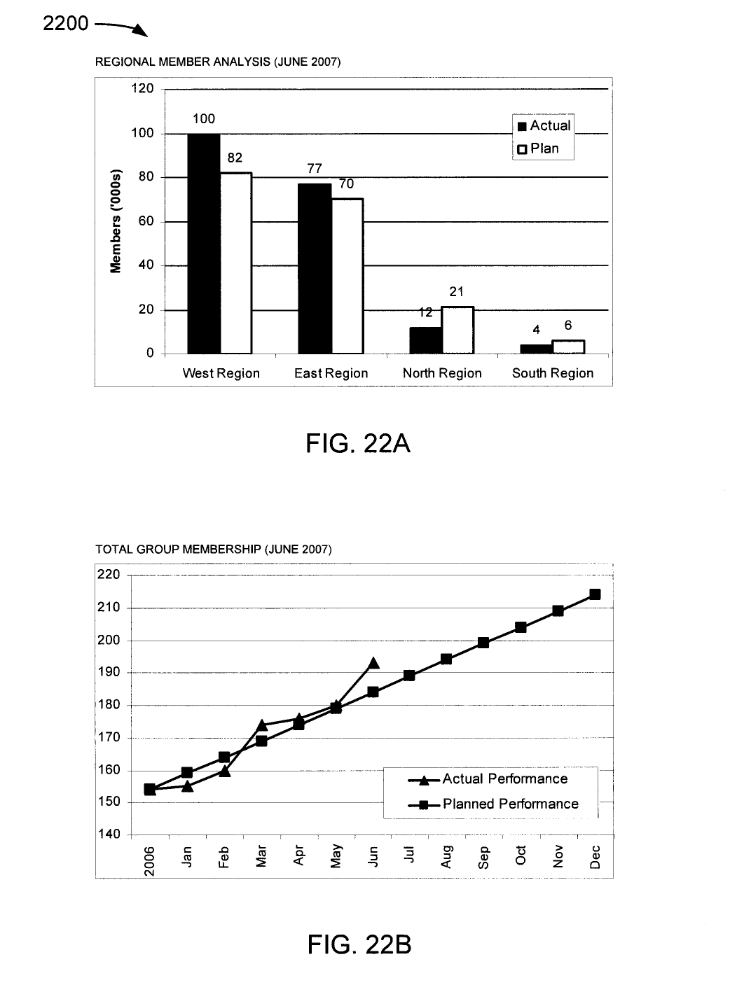

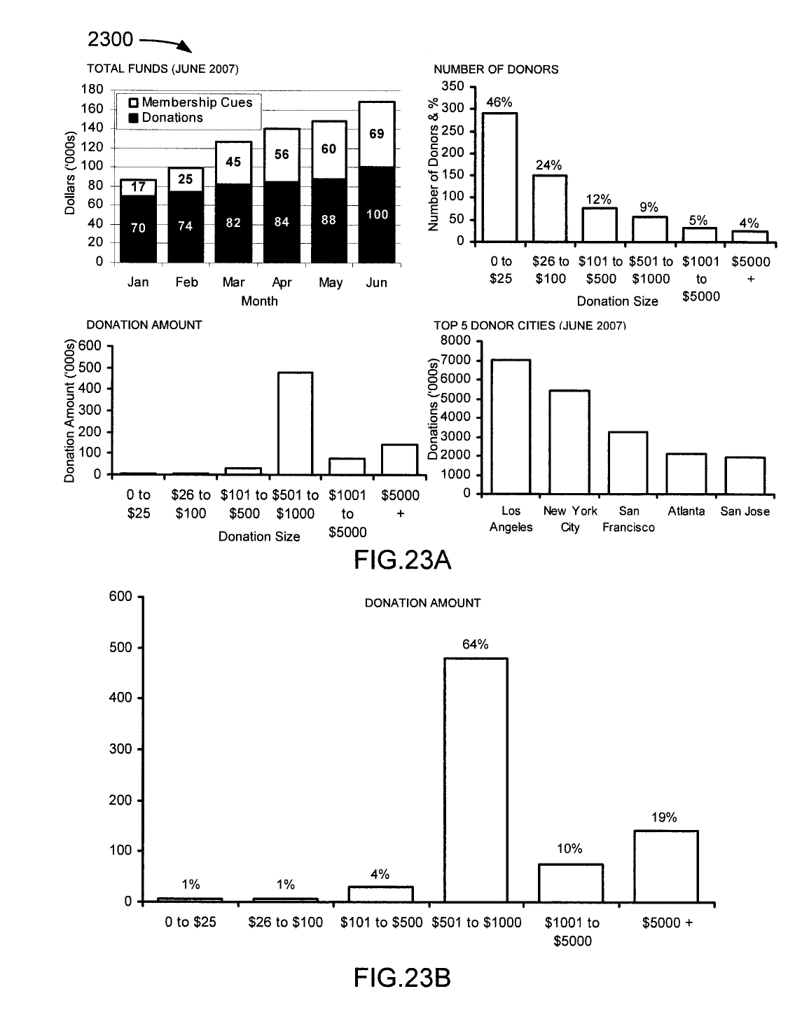

Further specific profile information about the groups can be displayed, as is shown in non-limiting example FIG. 19. Further, a variety of specific group metrics, statistics, and other information can be displayed, for example, the top group, largest group, fastest growing, most members, highest rated blog, highest rated video, top search group, highest rated article, and highest rated news can be determined. FIG. 21 displays a non-limiting example of a page providing metrics, statistics and other information. Group members can request detailed charting and graphing of this information as well. FIG. 22A-B, display examples of pages showing growth in membership of a group. FIG. 23A-B display pages of funding information which can be used to track donations to the group. The pages include detail of the group's donation amounts and specific statistics, for example, geographic descriptions such as top 5 cities, a histogram of donation amount, number of donors and total funds. Having visualized the group and group members, the flowchart terminates.

FIG. 24 depicts a template of a page be used to create a page with group information. The group information page includes one or more interface templates including one or more options to integrate group information from one or more records. The templates can be standardized to include one or more fixed locations, each displaying a specific type of information. Options can also be standardized. However, when implemented by the group head or group members, the options can be used in different ways to make radically different interfaces. Group information can be linked to the template, for example, via the options, in order to populate the interface with group information.

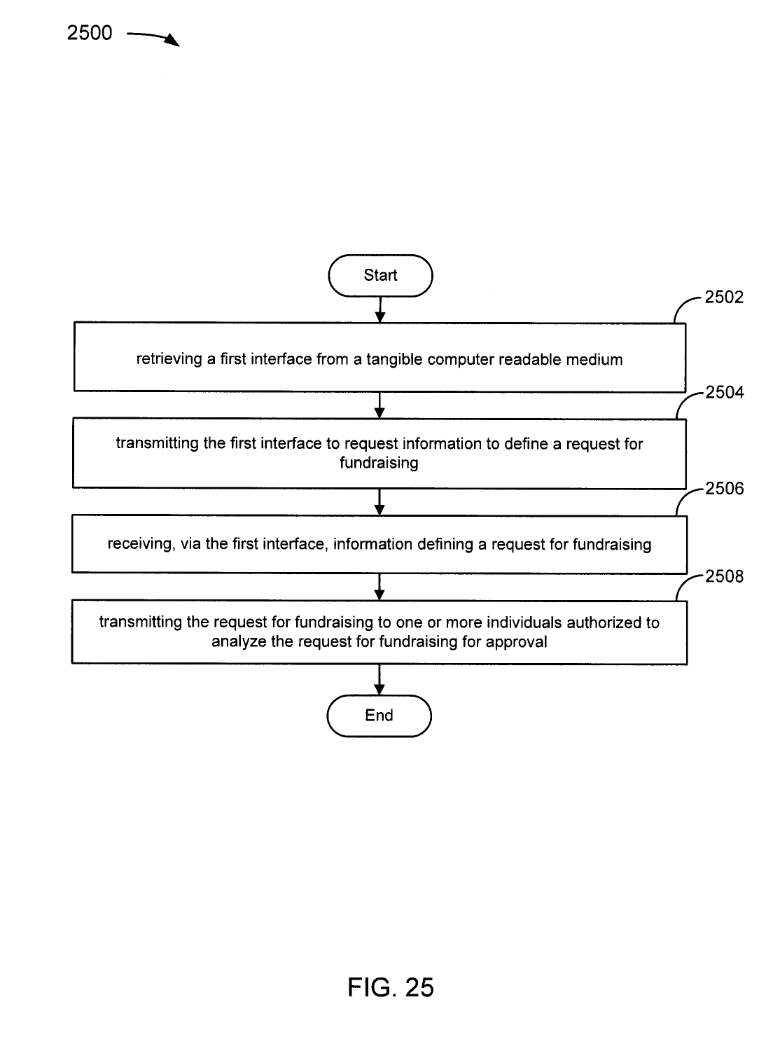

FIG. 25 depicts an example of a flowchart 2500 of a method for requesting funding using a public interface and a private interface. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

In the example of FIG. 25, the flowchart starts at module 2502 with retrieving a first interface from a tangible computer readable medium. The interface can be designed to collect information from a group member or members seeking fundraising for group activities. Such an interface can define the information to be collected on behalf of individuals or committees that will approve or provide the funding. The interface defines a standard funds request application allowing easy review by fund allocation entities.

In the example of FIG. 25, the flowchart continues to module 2504 with transmitting the first interface to request information to define a request for fundraising. The interface can be electronically transmitted. In a non-limiting example, the hypertext transfer protocol can be used to transmit the interface as a web page.

In the example of FIG. 25, the flowchart continues to module 2506 with receiving, via the first interface, information defining a request for fundraising. The information can be tailored to the interface and can include requests for video, documentation, an executive summary, a financial plan, a presentation and any additional information known or convenient for the fundraising process.

In the example of FIG. 25, the flowchart continues to module 2508 with transmitting the request for fundraising to one or more individuals authorized to analyze the request for fundraising for approval. Such transmission can include videos and documentation defining the request for fundraising and summarizing key reasons for the fundraising request. Such individuals can be members of the group, members of other groups, members of charities, foundations, wealthy individuals, or any known or convenient individuals involved in the funding process. Such individuals can then transmit an approval for the request as well as the funds. The group members can then receive the approval and funding. Having transmitted the request for fundraising, the flowchart terminates.

FIGS. 26 to 31 include screenshots of various examples. The screenshots are intended to be exemplary only and are not indented to be limiting. FIG. 26 depicts a screenshot 2600 of an example of a knowledge management center displaying an implementation of widgets. Various administrative functions are displayed and group widgets are displayed including group affiliation and author information. FIG. 27 depicts a screenshot 2700 of a knowledge management center displaying documents created by group members. In the example, the documents describe boards and fundraising information useful in, for example, picking good fundraisers.

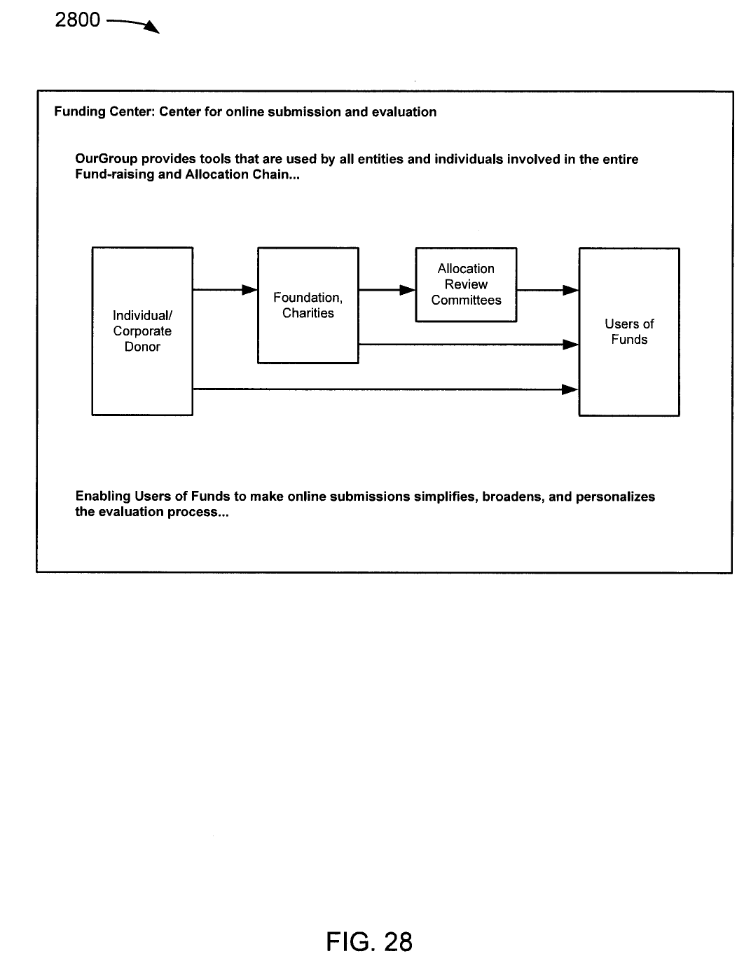

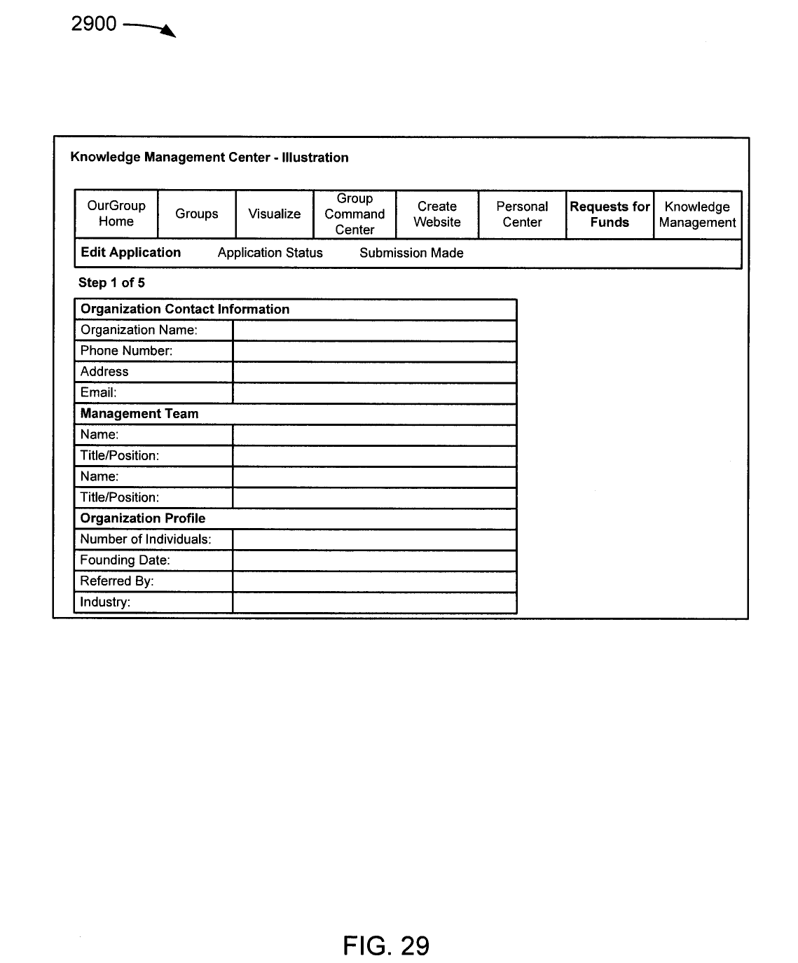

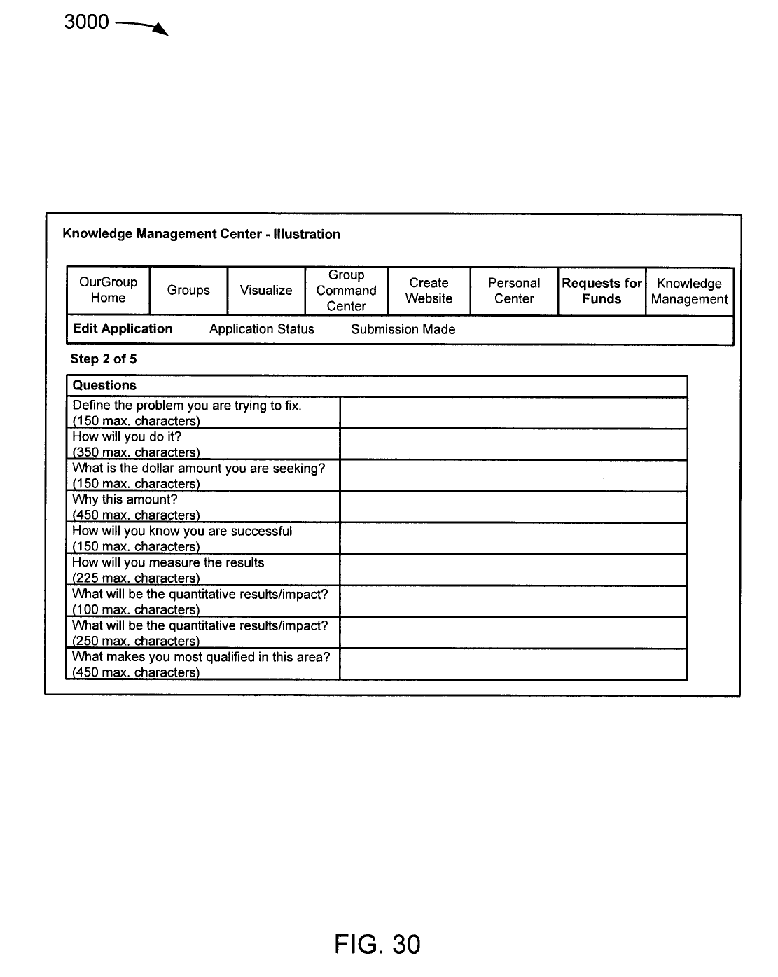

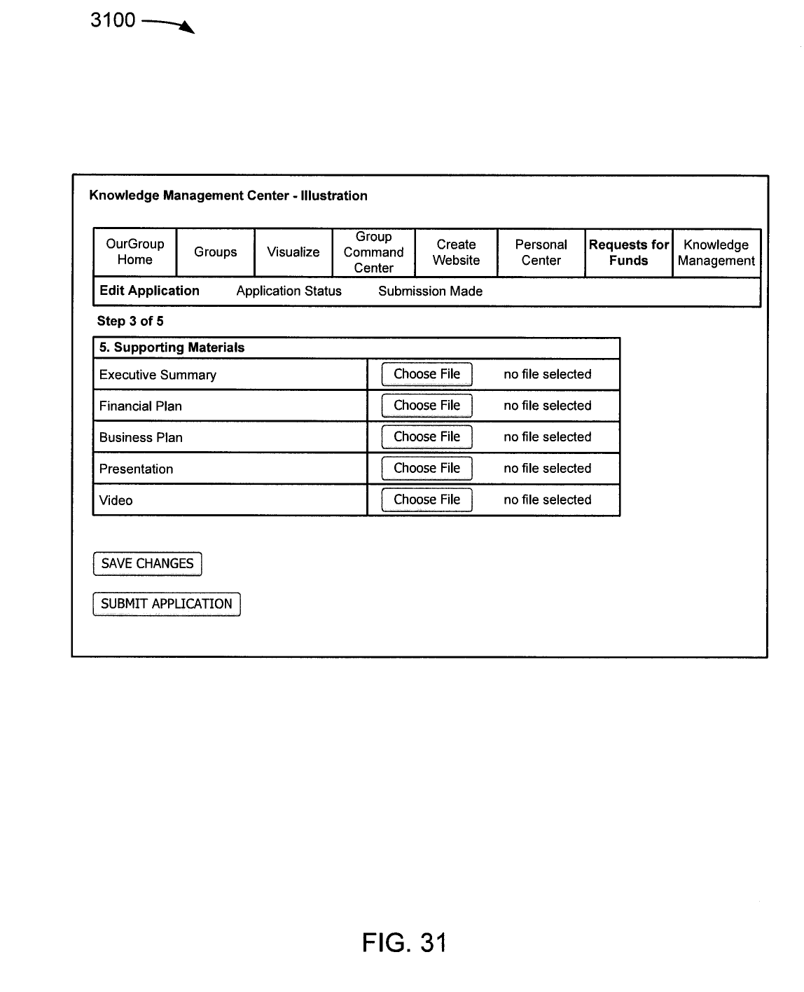

FIG. 28 depicts a screenshot 2800 of a flow diagram depicting a fundraising and fund allocation chain. In the example of FIG. 28, the flow begins with individual donors who provide funds directly to users of funds or alternatively to foundations and charities. Such foundations and charities can provide the funding to users of funds directly or indirectly through allocation review committees. FIG. 29 depicts a screenshot 2900 of an example of an interface that can be used to request funds, as discussed above. In the example of FIG. 29, the interface can collect group information such as contact, management, and profile information. FIG. 30 depicts a screenshot 3000 of an example of an interface that can be used to define reasons for fundraising. Such reasons could include problems to be solved, funds desired, quantitative and qualitative measures for success, and qualifications for requesting funding. FIG. 31 depicts a screenshot 3100 of an example of an interface that can be used to provide supporting materials to a request for fundraising. Such supporting materials can include summaries, plans, presentations, videos and other known or convenient request support materials.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is Appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to apparatus for performing the operations herein. This Apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other Apparatus. Various general purpose systems may be used with programs in accordance with the teachings herein, or it may prove convenient to construct more specialized Apparatus to perform the required method steps. The required structure for a variety of these systems will appear from the description below. In addition, the present example is not described with reference to any particular programming language, and various examples may thus be implemented using a variety of programming languages.

What is claimed is:

1. A system comprising:
a private group interface;
a public group interface;
a group record storage;
a group success statistics module;
wherein, in operation,
the private group interface receives fundraising information from one or more group members associated with a group operating the private group interface and the public group interface and stores the information in the group record storage;
the group success statistics module analyzes the fundraising information in relation to projected fundraising information stored in the group record storage to produce success statistics and to store the success statistics in the group record storage; and
the public group interface receives a request to view success statistics and retrieves and provides the success statistics in response to the request.

2. The system of claim 1 further comprising a group knowledge management engine, wherein in operation, the group knowledge management engine links group information stored in the group record storage.

3. The system of claim 1 further comprising a group knowledge search module, wherein in operation, the group knowledge search module responds to search requests with records stored in the group record storage.

4. The system of claim 3 wherein the search requests are received using the private group interface.

5. The system of claim 3 wherein the search requests are received using the public group interface.

6. A method of collecting information from group members comprising:
executing instructions stored in a tangible computer readable medium to produce an interface operable to receive contact information for individuals comprising a group identifiable by criteria provided to the interface;
receiving at the interface, one or more units of contact information, each unit of contact information associated with a group member identified by the criteria, including at least one group head; and
storing the one or more units of contact information in a database relating the individuals by the criteria.

7. The method of claim 6 further comprising collecting a definition of the group including one or more factors commonly identifying members of the group.

8. The method of claim 6 further comprising comparing the received contact information with contact information of group members of existing groups to identify connections between groups.

9. The method of claim 6 further comprising providing one or more widgets collecting knowledge from the group member.

10. The method of claim 6 further comprising visualizing authenticity of an identity of a group member by displaying a green light above an image representing the member.

11. The method of claim 6 further comprising visualizing failed authentication of identity of a group member by displaying a red light above an image representing the member.

12. The method of claim 6 further comprising visualizing activation of a group member profile by displaying a yellow light above an image representing the member.

13. The method of claim 6 further comprising visualizing that a member has not yet activated a profile by displaying a grey light above an image representing the member.

14. The method of claim 6 further comprising receiving group fundraising goals and prior fundraising.

15. A method of visualizing a relationship between groups comprising:
retrieving one or more records of group members from a tangible computer readable medium;
graphically displaying the one or more group members as a first group including a graphic representation of criteria linking individuals of the first together including a common group member of both the first group and a second group;
graphically displaying one or more members of the second group including the common group member; and
displaying a connection between the first group and the second group as a graphic representation between the first group to the second group as connected by the common group member.

16. The method of claim 15 wherein the second group is a subgroup of the first group.

17. The method of claim 15 wherein the first group is a group of non-profit organizations.

18. The method of claim 15 further comprising visualizing relationships and commonalities between group members.

19. The method of claim 15 further comprising visualizing importing a group member.

20. A method of creating a group interface comprising:
retrieving one or more records of a group from a tangible computer readable medium;
displaying one or more interface templates to a group member including one or more options to integrate group information from the one or more records;
displaying a toolbox including one or more widgets to include in the interface;
receiving a selection of zero or more of the options and zero or more widgets;
populating the interface with the group information from the one or more records; and
providing the interface including the selected options.

21. The method of claim 20 wherein the options include surveys, blogs, voting fundraising buttons.

22. The method of claim 20 wherein the widgets are created by members of the group.

23. The method of claim 20 further comprising presenting the interface personalized to an individual group member.

24. The method of claim 20 wherein the interface includes options for a group head to manage the group.

25. The method of claim 20 wherein the group interface includes an option for a group head to send a message to one or more group members while maintaining confidentiality of contact information of the group members.

26. A method of visualizing performance of a group comprising:
retrieving records of actual group fundraising and records of planned group fundraising from a tangible computer readable medium;
identifying deficiencies and successes in actual group fundraising relative to the planned group fundraising; and
displaying one or more charts of the actual fundraising and one or more charts of the planned group fundraising including one or more indications of deficiency and success in group fundraising.

27. The method of claim 26 further comprising limiting the records of actual group fundraising and the records of planned group fundraising to a geographically bounded area.

28. The method of claim 26 further comprising limiting the records of actual group fundraising and planned group fundraising to a subset of group members.

29. A method of managing a group of individuals comprising:
retrieving group member records from a tangible computer readable medium;
providing the group member records to a group head via an interactive graphical user interface;
receiving a request from the group head to provide information to one or more group members; and
providing the information to the one or more group members.

30. The method of claim 29 further comprising receiving an information request from the group head to provide to the group members.

31. The method of claim 29 further comprising providing the information request to the group members and receiving responses from the group members.

32. The method of claim 29 further comprising receiving an instruction to change access permission to a group interface for a group member.

33. The method of claim 29 wherein the request includes a survey and providing the request includes providing the survey to one or more group members;

34. The method of claim 29 further comprising surveying group members and receiving responses from the group members.

35. The method of claim 29 further comprising identifying a group member having the highest fundraising performance.

36. The method of claim 29 inviting one or more members to the group.

37. The method of claim 29 providing a document to the group members.

38. A method of highlighting performance of multiple groups comprising:
retrieving records of group activities for two or more groups from a tangible computer readable medium;
aggregating the records for each group by a criterion to create an aggregate records of each group;
sorting the aggregate records by the criterion; and
displaying the aggregated records to thereby identify the most successful groups per the criterion.

39. The method of claim 38 wherein the criterion includes a rating of a blog associated with each group.

40. The method of claim 38 wherein the criterion includes a total amount of funds raised.

41. The method of claim 38 wherein the criterion includes a group video.

42. The method of claim 38 wherein the criterion is a group category selected from health, environment, politics, and religion.

43. A method of requesting funding comprising:
retrieving a first interface from a tangible computer readable medium;
transmitting the first interface to request information to define a request for fundraising;
receiving, via the first interface, information defining a request for fundraising; and
transmitting the request for fundraising to one or more individuals authorized to analyze the request for fundraising for approval.

44. The method of claim 43 further comprising receiving approval of the request for fundraising.

45. The method of claim 43 further comprising receiving notification of disbursement of funds.

46. The method of claim 43 wherein the first interface is a private interface.

47. The method of claim 43 wherein the first interface includes a request for a video and the information defining a request for fundraising includes a video summarizing key reasons for the funding request and an expected impact from the funding.

48. The method of claim 43 wherein the request for fundraising is transmitted to one or more recipients selected from individual donors, foundations and charities.

49. The method of claim 43 wherein the first interface includes widgets.

50. The method of claim 43 wherein the first interface includes a request for one or more units of information selected from an executive summary, a financial plan, a presentation, and a video.

51. A method of allocating funding based on requests for funds, comprising:
receiving, via a first interface, information defining a request for fundraising, wherein the information is in a predefined format;
displaying the information defining the request for fundraising to an allocation review entity for review; and
responsive to an allocation review entity input, granting the fundraising request.

52. The method of claim 51 further comprising transmitting the approval of the request for fundraising after ranting the fundraising request.

53. The method of claim 51 further comprising authorizing disbursement of funds.

54. The method of claim 51 wherein the first interface is a private interface.

55. The method of claim 51 wherein the information includes a video regarding the request for fundraising.

56. The method of claim 51 wherein the information is displayed to one or more recipients selected from individual donors, foundations and charities.

57. The method of claim 51 wherein the first interface includes widgets.

58. The method of claim 51 wherein the information includes one or more units of information selected from an executive summary, a financial plan, a presentation, and a video.

59. A system for knowledge management, comprising:
a private group interface for use by members of a defined group;
a public group interface for use by members not of the defined group;
a group record storage;
a group knowledge management engine;
wherein, in operation,
the group knowledge management engine manages group information submitted by members of the defined group,
the private group interface and the public group interface receive group information relevant to the defined group and store the information in the group record storage,
responsive to a user request, the management engine retrieves group information for display at the private group interface and the public group interface.

60. The system of claim 59 further comprising a group knowledge search module, wherein in operation, the group knowledge search module services search requests with search results regarding records stored in the group record storage.

61. The system of claim 60 wherein the search requests are received using the private group interface.

62. The system of claim 60 wherein the search requests are received using the public group interface.
